(19) United States
(12) Patent Application Publication
(10) Pub. No.: US 2008/0271556 A1
(43) Pub. Date: Nov. 6, 2008

(54) ROTATION DRIVE UNIT AND IMAGE FORMING APPARATUS USING SAME

(75) Inventors: Tadashi Imamura, Kyoto (JP); Takeo Tokuda, Kyoto (JP); Tsuyoshi Yamamura, Kyoto (JP)

Correspondence Address: PEARNE & GORDON LLP, 1801 EAST 9TH STREET, SUITE 1200, CLEVELAND, OH, 44114-3108, US

(73) Assignee: NIDEC-SHIMPO CORPORATION, Kyoto (JP)

(21) Appl. No.: 12/044,127

(22) Filed: Mar. 7, 2008

(30) Foreign Application Priority Data
Mar. 9, 2007 (JP) 2007-60417
Mar. 12, 2007 (JP) 2007-62260
Feb. 15, 2008 (JP) 2008-35312
Feb. 15, 2008 (JP) 2008-35316

(51) Int. Cl. F16H 1/20; G03G 15/00

(52) U.S. Cl. 74/412 R; 399/167

(57) ABSTRACT

A rotation drive unit having a first reduction mechanism of traction transmission system comprising a drive roller attached to a drive shaft and a driven roller attached to a driven shaft, and a second reduction mechanism of gear transmission system comprising a drive gear attached to the drive shaft and a driven gear attached to the driven shaft. The first reduction mechanism generates a braking effort while making slippage between the rollers during transmission of a rotational driving force from the drive shaft, and exerts a torque load on the second reduction mechanism of the gear transmission system. Since this unit transmits the rotational driving force via the first reduction mechanism while exerting the load upon the second reduction mechanism, it provides a satisfactory and reliable speed-reducing function as well as reliable and accurate transmission of the rotational driving force even if equipped with a plurality of driven shafts coupled to the single drive shaft. The rotation drive unit is suitable for driving photoconductor drums of an image forming apparatus. The rotation drive unit thus provides a sufficient speed-reducing function while effectively avoiding the need to increase a size of the apparatus even in a structure having a plurality of driven members.

### FIELD OF THE INVENTION

The present invention relates to a rotation drive unit and a speed reduction unit capable of reducing a rotating speed smoothly, and typical application techniques of them in a mechanism for transmitting a rotational force from a driving source to a rotating member. In particular, the invention relates to the rotation drive unit and the speed reduction unit suitable for rotationally driving a plurality of photoconductor drums provided in an image forming apparatus of a type utilizing color electro-photographic printing system. The invention also relates to the image forming apparatus equipped with the rotation drive unit and the speed reduction unit.

### BACKGROUND OF THE INVENTION

In an image forming apparatus utilizing the electro-photographic printing system, an ordinary structure hitherto known employs an inertial body such as a flywheel attached to a driven shaft of a photoconductor drum. Such an inertial body is provided for the purpose of stabilizing rotational vibrations, reducing a rotating speed and the like of the photoconductor drum by increasing an inertial force of the photoconductor drum during the rotation.

Normally, the photoconductor drum rotates at a speed comparatively lower than a rotating speed exerted by a motor used as a driving source. This therefore makes it necessary to use the flywheel of a large diameter as the inertial body. On the other hand, due to the tendency in recent years of increasing demand for further downsizing of image forming apparatuses, large-size flywheel is one of the obstacles that prevent the reduction in size of the image forming apparatuses. A variety of techniques have hence been proposed to reduce size of the flywheel.

Japanese Patent Unexamined Publication, No. H05-100508 (published on Apr. 23, 1993, which is referred to as patent document 1), for instance, addresses the above problems, and discloses a structure that connects a shaft of a photoconductor drum and a shaft of a flywheel with a transmission means having a speed-increasing function to achieve its objects such as (1) preventing vibrations generated by the flywheel from being transmitted to the photoconductor drum so as to avoid an adverse effect on image formation, and (2) reducing a weight of the flywheel by making it smaller in size and reducing the space required for installation of it.

It is taught that the flywheel can be made less in weight and smaller in size thereby needing a smaller space for installation thereof since the flywheel can be rotated at a higher speed by virtue of the transmission means provided with the speed-increasing function, according to the structure illustrated above. Specific examples noted as the above transmission means having the speed-increasing function include a structure comprising a drive gear of large diameter engaged with a driven gear of small diameter, combinations of belt pulleys, chain sprockets, and the like.

Another Japanese Patent Unexamined Publication, No. 2002-268459 (published on Sep. 18, 2002, patent document 2) is directed to an object of reducing diameter of the flywheel or eliminating it at all, so as to remove the restriction on placement of other components around the drive unit, and discloses a structure of a photoconductor drum having a partition provided inside thereof to achieve the object.

It is shown that the above structure allows placement of an insertable member within the photoconductor drum to increase an inertial mass of it, which suppresses rotational fluctuations of the photoconductor drum, and thereby it can provide the photoconductor drum with the flywheel of a reduced diameter or no flywheel on the shaft of the drum.

In the case of an image forming apparatus of a type provided with a plurality of photoconductor drums, such as a color image forming apparatus having four photoconductor drums to individually form electrostatic latent images of four colors, or yellow (Y), magenta (M), cyan (C) and black (K), for instance, it is necessary to attach a flywheel to each of these drums. It is for this reason that the reduction in size of the individual flywheels alone, as taught by the techniques disclosed in the above-referred patent documents 1 and 2, does not provide sufficient contribution to such color image forming apparatuses for further downsizing of the apparatuses.

In general, the so-called tandem type is the system used widely for the image forming apparatuses provided with a plurality of photoconductor drums to form color images discussed above. In the case of an apparatus provided with four photoconductor drums to form electrostatic latent images of four colors consisting of the aforesaid Y, M, C and K respectively, for instance, it is called the tandem type because these photoconductor drums are disposed in tandem along a traveling direction of an intermediate transfer medium (e.g., intermediate transfer belt) or a recording medium (e.g., a sheet of paper).

The above image forming apparatus of the tandem type produces a color image by driving the plurality of photoconductor drums generally simultaneously in a synchronized motion to transfer toner images of different colors on the individual photoconductor drums onto the intermediate transfer medium being rotated or the recording medium being transferred in a sequentially superimposing manner. Since color image forming apparatuses of the tandem type has a greater capability of enhancing the image formation speed as compared with the image forming apparatuses of other types, they have been used widely in the recent years.

In the above structure, however, there is a possibility that quality of the formed color images is impaired when the toner images shift out of register, since it undergoes a process of registering the toner images of different colors. In the light of improving quality of the color images, it is therefore necessary to attain a high rotating accuracy of the plurality of photoconductor drums, such that (1) they are kept synchronized with high accuracy, (2) they are rotated without irregularity in the best possible manner, and so on. It is especially necessary to maintain the accurate synchronization in order to reduce an adverse influence of periodic misregistration as little as possible.

To be more specific, the rotating speed of the photoconductor drums includes a certain component of periodical variations in the speed that is attributed to decentering in the axis of rotation, and the like. This component of speed variations produces periodic misregistration amongst the plurality of photoconductor drums. To this end, some techniques have been proposed such as the one disclosed in Japanese Patent Unexamined Publication, No. 2005-345668 (published on Dec. 15, 2005, patent document 3), in which the component of speed variations is detected appropriately and used for driving control of the photoconductor drums.

In this technique, two registering patterns having different phases of the component of speed variations are deleted with a pattern sensor, and the result is used to calculate a value, which exclude an influence of the component of speed variations of at least one of the individual photoconductor drums and the transfer belt. Since this technique provides the component of speed variations of at least one of the individual photoconductor drums and the transfer belt, it enables detection of components of speed variations of both the transfer belt and the photoconductor drum separately without using other sensor, writing means and the like, in addition to the pattern sensor used as a register sensor in the conventional apparatus

Beside the decentering in the axis of rotation of the photoconductor drum, there are also other conceivable causes of the periodic misregistration discussed above, such as effects attributable to decentering of a flywheel used with the photoconductor drum, decentering of a rotating speed detector, and the like.

There are some techniques proposed for this purpose, such as the one disclosed in Japanese Patent Unexamined Publication, No. 2006-154352 (published on Jun. 15, 2006, patent document 4), which is to detect a rotating speed of the photoconductor drum by means of detecting slits formed in a drive gear for the purpose of detection.

This technique makes it unnecessary to increase a size of the flywheel for reduction of irregular rotation since the slits for rotation detection formed in the drive gear are intended for rectifying the irregular rotation of the photoconductor drum in a one-to-one relationship. This technique can hence detect the irregular rotation of the photoconductor drum directly and highly accurately while also simplifying and downsizing the structure around the photoconductor drum.

There is another known technique for reducing misregistration and inconsistencies in density of formed color images by means of controlling rotation of individual photoconductor drums and an intermediate transfer belt in a coordinated manner, although this technique applies only to image forming apparatuses of the type provided with a rotary transfer medium such as the intermediate transfer belt. A specific example of this technique, as disclosed in Japanese Patent Unexamined Publication, No. 2006-201270 (published on Aug. 3, 2006, patent document 5), is to cancel out variations of workload due to irregular rotating speed with variations in rotating speed imposed upon the intermediate transfer medium by controlling rotating phases of the individual photoconductor drums.

This technique focuses on the fact that a main component of the variations in rotating speed has a frequency corresponding to one full rotation of the photoconductor drum, and, in an example of a structure comprising four photoconductor drums of Y, M, C and K disposed in tandem, the four photoconductor drums are rotated individually to calculate variations in the speeds and stopped positions of the individual photoconductor drums, and these data are used to determine the subsequent start-up timings.

In all of the conventional color image forming apparatuses of the tandem type discussed above, however, it is necessary to synchronize the rotating phases of the individual photoconductor drums over their full rotating cycle because the rotating phases need to be aligned by controlling the driving means of rotating the photoconductor drums. They therefore have a drawback of not allowing an increase in size of one of the photoconductor drums for K color, of which a frequency of use is very high.

In the case of the patent document 3, in particular, different driving processes are carried out between drive motors, one for driving a photoconductor drum used to form a black (K) image (i.e., photoconductor drum for black image), and the other used to form three color images (C, M and Y) (i.e., photoconductor drums for chromatic color image). In the process here, a start-up control is made on the drive motor of the photoconductor drum for K color and another drive motor of the photoconductor drum for cyan image, which is closest to the photoconductor drum for black image, in a manner to bring the photoconductor drum for black image and the photoconductor drum for cyan image into the same phase.

In other words, it is necessary to determine a deviation in the phases between the photoconductor drum for black image and the photoconductor drum for cyan image, and control them in a manner to bring them into the same phase. However, it becomes impossible for this control to bring them into the same phase when the system has such a design that rotating speeds are different between the photoconductor drum for black image and the photoconductor drum for cyan image, or if the former has a larger diameter than the latter, because their rotating cycles themselves become different.

In addition, the above patent document 3 shows photoconductor drums having drive gears, which constitute a gear train with their rotating phases synchronized over a full rotating cycle, thereby reducing deviations in positions that occur among the individual photoconductor drums for chromatic color images. However, this structure still leaves the problem of variations in the speed over the full rotating cycle, which is attributable to such factors as pitch errors of the gears accumulated during the manufacturing process, and decentering in the axis of rotation developed in the rotation drive system. It therefore gives rise to a drawback of leaving distortion in the image over the full rotating cycle of the photoconductor drums.

The patent document 4 discloses a structure, in which a rotational driving force of the drive motor is transmitted to a drive gear of the photoconductor drum for cyan image as well as a drive gear of the photoconductor drum for yellow image to drive and rotate the both photoconductor drums, and the rotational driving force of the photoconductor drum for cyan image is transmitted in turn to a drive gear of the photoconductor drum for magenta image via an idler gear to drive and rotate the photoconductor drum for magenta image. In other words, all of the three photoconductor drums for chromatic color images are driven by one drive motor. On the other hand, a photoconductor drum for black image is driven by another drive motor, which is independent from the above photoconductor drums for chromatic color image in this structure.

The patent document 4 thus has a separate control for rotationally driving the photoconductor drum for black image from that of the photoconductor drums for chromatic color images, as similar to the patent document 3. In this system, an encoder is used to directly detect rotating speeds of the photoconductor drums, and to individually control the drive motor of the photoconductor drum for black image and the drive motor of the three photoconductor drums for chromatic color images in a manner to eliminate rotational irregularities based on the rotating speeds. Similar to the patent document 3, it is also difficult for the above reason to carry out the driving control to eliminate the rotational irregularities, according to the patent document 4, when the rotating speed of the photoconductor drum for black image is increased or a size of the photoconductor drum for black image is increased larger than that of the photoconductor drums for chromatic color.

Furthermore, the patent document 5 discloses the structure provided with four photoconductor drums for Y, M, C and K colors having generally the same material and size, and also same motor for driving them. Therefore, it is practically difficult to increase a size of the photoconductor drum for black image or a rotating speed thereof, like those of the patent documents 3 and 4.

### SUMMARY OF THE INVENTION

The present invention is devised in the light of the above problems, and it is an object of this invention to provide a rotation drive unit of a structure having a plurality of rotationally driven members such as photoconductor drums, and capable of offering a substantial speed-reducing function while avoiding an increase in size of a drive system for the rotationally driven members. The rotation drive unit is also adapted to improvement of the design flexibility of the photoconductor drum for black image, of which a frequency of use is very high, such as increase in rotating speed and size, and not requiring a complicated control of phase synchronization. Another object of the invention is to provide an image forming apparatus equipped with the above rotation drive unit.

As a result of the diligent study with the above problems in mind, we, the inventors of the present invention found out that it is necessary for a color image forming apparatus equipped with a plurality of photoconductor drums, for instance, to have the functions of not only reducing a rotating speed of the drams, but also transmitting the rotating speed reliably and smoothly in order to achieve appropriate registration of color images consisting of Y, M, C and K colors, and we hence completed the present invention.

The present inventors also found out, after the further study in the light of the above problems, that, in a structure having a single unit of driving source for driving a plurality of photoconductor drums for chromatic color images altogether but independently of another driving source for a photoconductor drum for black image, it becomes not necessary to synchronize phases of driving rotation of the individual photoconductor drums by adopting a new method, in which a rotating speed of only one of the photoconductor drums is detected for each of the driving sources, and rotating speeds of the driving sources are adjusted in a manner to cancel out rotational variations over their full rotating cycle, thereby achieving improvement of the design flexibility of the photoconductor drum for K color, of which a frequency of use is very high. The present inventors hence completed this invention.

In other words, the rotation drive unit of the present invention includes a rotation drive mechanism provided with a drive shaft and a driven shaft juxtaposed in parallel to each other, wherein the drive shaft has at least a concentrically attached drive gear, the driven shaft has at least a concentrically attached driven gear, the drive gear and the driven gear are rotatably engaged to compose a gear train for transmitting a rotational driving force of the drive shaft to the driven shaft, and the rotation drive unit further comprises a rotating speed controller for reducing a deviation of an actual value from an expected value in rotating speed of a rotationally driven member in concentricity with a rotating axis of the driven shaft when the driven shaft is engaged to the rotationally driven member, wherein the expected value denotes a rotating speed of the rotationally driven member expected according to a rotating condition of the drive shaft, and the actual value denotes an actual rotating speed of the rotationally driven member.

More specifically, the rotation drive unit includes a speed reduction mechanism provided with the drive shaft and the driven shaft disposed in parallel to each other, wherein the drive shaft has a drive roller and a drive gear concentrically attached thereto, the driven shaft has a driven roller and a driven gear concentrically attached thereto, the drive roller and the driven roller are rotatably in contact with each other to compose a first reduction mechanism for transmitting a rotational driving force of the drive shaft to the driven shaft, the drive gear and the driven gear are rotatably engaged to compose a second reduction mechanism for transmitting the rotational driving force of the drive shaft to the driven shaft, and a reduction ratio of rotating speed of the first reduction mechanism is set to be different from a reduction ratio of rotating speed of the second reduction mechanism when the first reduction mechanism and the second reduction mechanism are compared on an assumption of transmitting the rotational driving force independently from the drive shaft to the driven shaft. In this structure, the first reduction mechanism and the second reduction mechanism constitute the aforesaid rotating speed controller.

In another aspect, a rotation drive unit is installed in an image forming apparatus provided with a plurality of photoconductor drums for forming toner images of different colors, the plurality of photoconductor drums comprising ganged photoconductor drums having same diameter and rotated in a linked motion by a rotational driving force of a single driving source, wherein the ganged photoconductor drums are provided with driven gears formed by a same single molding die and attached individually to rotary shafts thereof, the driven gears are aligned in the same orientation to balance dimensional deviations in their pitch radii at their engaged portions and assembled with an intermediate gear disposed and meshed between every adjoining driven gears to compose a gear train, and the rotation drive unit further comprises a pulse plate having markings formed in a circular pattern at equal intervals and mounted to one of the rotary shafts of the ganged photoconductor drums, detectors (sensors) disposed at positions equally dividing a circumferential area around the rotary shaft for detecting the markings on the pulse plate and generating a speed signal, and a rotating speed regulator for regulating a rotating speed of the driving source based on the speed signal generated by the detectors in a manner to bring a speed of the rotary shaft into conformity with a predetermined rotating speed. In this structure, the pulse plate, the detectors and the rotating speed regulator constitute the above rotating speed controller.

In addition, the present invention includes an image forming apparatus equipped with the above rotation drive unit. A color image forming apparatus of a type using the electro-photographic printing system can be named as a concrete example of the image forming apparatus. The color image forming apparatus is provided with a plurality of photoconductor drums to form a color image by transferring toner images of different colors in a manner to superimpose one after another. The above rotation drive unit, when used for driving and rotating the plurality of photoconductor drums, can achieve more adequate rotation of the individual photoconductor drums, so as to effectively avoid misregistration in colors during the process of registering the toner images of the different colors.

### BRIEF DESCRIPTION OF THE FIGURES

FIG. 1 is a schematic view showing a typical structure of a rotation drive unit according to one exemplary embodiment of the present invention;

FIG. 2 is a perspective view showing an exemplary structure of a major portion of the rotation drive unit shown in FIG. 1;

FIG. 3(a) to FIG. 3(c) are partially sectioned views schematically showing exemplary structures, each consisting of a drive roller, a driven roller, a drive gear and a driven gear in the rotation drive unit shown in FIG. 2;

FIG. 4 is a perspective view showing an exemplary structure of a major portion of a rotation drive unit according to another exemplary embodiment of the present invention;

FIG. 5 is a plan view schematically showing in part a state of engagement of a drive gear and a driven gear in the rotation drive unit shown in FIG. 4;

FIG. 6(a) to FIG. 6(c) are partially sectioned views schematically showing exemplary structures, each consisting of a drive roller, a driven roller, a drive gear and a driven gear in the rotation drive unit shown in FIG. 4;

FIG. 7 is a perspective view showing in part an exemplary structure of a major portion of a rotation drive unit according to another exemplary embodiment of the present invention;

FIG. 8 is a perspective view showing in part another exemplary structure of the rotation drive unit shown in FIG. 7;

FIG. 9 is a sectional view schematically showing in part a state of contact of an idle roller with a driven roller in the rotation drive unit shown in FIG. 8;

FIG. 10(a) and FIG. 10(b) are plan views, each showing schematically an example of a state of contact of the idle roller with the driven roller in the rotation drive unit shown in FIG. 8;

FIG. 11 is a perspective view showing in part still another exemplary structure of the rotation drive unit shown in FIG. 7;

FIG. 12 is a block diagram schematically showing a structure of a major portion of an image forming apparatus according to still another exemplary embodiment of the present invention;

FIG. 13 is a block diagram schematically showing an exemplary structure of a drive unit for use in an image forming apparatus according to yet another exemplary embodiment of the present invention;

FIG. 14 is a perspective view schematically showing an example of a gear train employed in a rotation drive system for photoconductor drums use in the drive unit shown in FIG. 13;

FIG. 15 is a graphic representation showing variations of rotating speeds of the photoconductor drums for chromatic color images in the drive unit shown in FIG. 13;

FIG. 16(a) is a block diagram schematically showing an exemplary structure of a drive unit used in an image forming apparatus according to another exemplary embodiment of the present invention;

FIG. 16(b) is a graphic representation showing variations of rotating speeds of individual photoconductor drums in the drive unit shown in FIG. 16(a);

FIG. 17(a) is a schematic view showing an example structure of a speed reduction mechanism of tractional system employed in a rotation drive unit for a photoconductor drum for black image in the drive unit shown in FIG. 16;

FIG. 17(b) is a schematic view showing another example structure for directly driving the photoconductor drum for black image by a motor in the drive unit shown in FIGS. 16(a) and 16(b);

FIG. 18(a) and FIG. 18(b) are partially sectioned views schematically showing detailed example structures of the speed reduction mechanism of tractional system shown in FIG. 17(a);

FIG. 19 is a table showing exemplified structures outlined based on differences in configurations of the four photoconductor drums and their reduction ratios in an image forming apparatus equipped with the drive unit shown in FIG. 16(a) and FIG. 16(b);

FIG. 20 is a plan view schematically showing a preferred example of the rotation drive unit for the photoconductor drums for chromatic color images in the drive unit shown in FIGS. 16(a) and 16(b); and

FIG. 21 is a schematic view illustrating the photoconductor drums attached to the extended driven shafts of the drive unit shown in FIG. 20.

### DETAILED DESCRIPTION OF PREFERRED EMBODIMENTS

### First Exemplary Embodiment

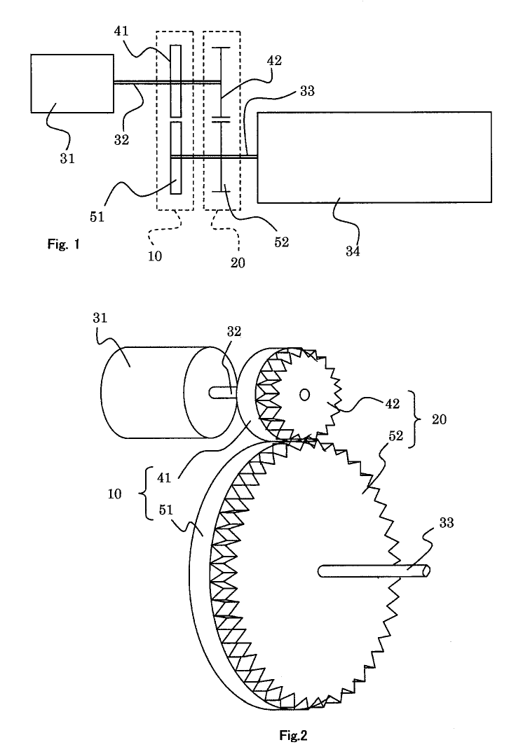

The following descriptions will explain one exemplary embodiment of the present invention with reference to FIG. 1 to FIG. 3. It should be understood, however, that the exemplary embodiment described herein is illustrative and not to be taken as restrictive. The present invention may be embodied or practiced in still many other ways without departing from the spirit and scope thereof, and all changes which come within the meaning and range of equivalency of the appended claims are therefore intended to be embraced therein.

As shown in FIG. 1, a rotation drive unit according to the present invention comprises motor, or driving source 31, drive shaft (driving shaft) 32, first reduction mechanism 10, second reduction mechanism 20 and driven shaft (slave shaft) 33. Driven shaft 33 is provided on rotationally driven member 34, which is driven by receiving a rotational driving force transmitted from motor 31. Rotationally driven member 34 illustrated in the present exemplary embodiment is photoconductor drum 34 used in an image forming apparatus of a type using the electro-photographic printing system. However, this is illustrative and not restrictive as needless to mention.

Drive shaft 32 and driven shaft 33 are arranged in parallel to each other, and these shafts are provided with rollers and gears to serve as rotational motion transmitters. To be more specific, drive gear 42 and drive roller 41 are attached in this order to the distal end of drive shaft 32 in such orientations that they are parallel to each other. Similarly, driven roller 51 and driven gear 52 are attached in this order to the distal end of driven shaft 33 in the same orientations parallel to each other. The above drive roller 41 and drive gear 42 are freely rotatable about the axis of drive shaft 32, and driven roller 51 and driven gear 52 are also rotatable about the axis of driven shaft 33.

Drive roller 41 and driven roller 51 are in contact with each other in a rotatable manner to constitute first reduction mechanism 10 for transmitting a rotational driving force of motor 31 from drive shaft 32 to driven shaft 33. Similarly, drive gear 42 and driven gear 52 are also engaged in a rotatable manner to constitute second reduction mechanism 20 for transmitting the rotational driving force of motor 31 from drive shaft 32 to driven shaft 33. Therefore, first reduction mechanism 10 can be referred to as a tractional transmission system, whereas second reduction mechanism 20 can be referred to as a gear transmission system. The speed reduction mechanism (i.e., speed reduction unit) of the present invention includes the aforesaid drive shaft 32, driven shaft 33, first reduction mechanism 10 and second reduction mechanism 20, as a combination of the least number of components.

A more specific example of the structure comprises drive roller 41 and drive gear 42 juxtaposed closely in parallel to each other and attached to drive shaft 32, and driven roller 51 and driven gear 52 also juxtaposed closely in parallel to each other and attached to driven shaft 33, as shown in FIG. 2. Drive roller 41 and driven roller 51 are kept in contact with each other in a mutually rotatable manner, so that the rotational driving force of motor 31 can be transmitted from drive roller 41 to driven roller 51.

In this instance, drive roller 41 and driven roller 51 constituting first reduction mechanism 10 are not simply in contact with each other, but are kept in a “thrust contact” condition, in which drive roller 41 and driven roller 51 press their respective surfaces against each other with a pressure. That is, drive roller 41 and driven roller 51 are capable to rotate together under the thrust contact condition, although they may rotate while slipping on their surfaces of contact.

The present invention is not intended to define or limit specific conditions and structures in order for drive roller 41 and driven roller 51 to maintain such a condition of contact that makes them capable of rotating while slipping on their surfaces, but the conditions or structures can be altered as needed depending on such variables and factors as surface materials of drive roller 41 and driven roller 51, torques of drive shaft 32 and driven shaft 33, and the like.

Furthermore, the condition of engagement between drive gear 42 and driven gear 52 that constitute second reduction mechanism 20 is not specifically defined, provided that the rotational driving force of drive shaft 32 can be transmittable to driven shaft 33 via the engagement of drive gear 42 and driven gear 52.

Incidentally, first reduction mechanism 10 and second reduction mechanism 20 have different reduction ratios from each other for reducing a speed of the rotational driving force from drive shaft 32. To be specific, the reduction ratio of rotating speed of first reduction mechanism 10 is set to be larger than the reduction ratio of second reduction mechanism 20 when compared on the assumption that they are operated independently for transmitting the rotational driving force of drive shaft 32 to driven shaft 33.

When the reduction ratios are set differently as described, rotating speed Vout2 transmitted to driven shaft 33 via second reduction mechanism 20 becomes larger than rotating speed Vout1 transmitted to driven shaft 33 via first reduction mechanism 10 (i.e., Vout2>Vout1) since rotating speed Vin of the rotational driving force delivered from drive shaft 32 is the same speed. In other words, the rotating speed Vout2 of driven shaft 33 via second reduction mechanism 20 is faster than the rotating speed Vout1 of driven shaft 33 via first reduction mechanism 10.

Here, first reduction mechanism 10 transmits the rotational driving force while causing slippage between drive roller 41 and driven roller 51a rather than at the theoretical rotating speed of Vout1, because the mechanism is designed to transmit the rotational driving force via the surface contact between drive roller 41 and driven roller 51a. Accordingly, the actual rotating speed Vreal of the rotational driving force transmitted by first reduction mechanism 10 becomes a value equivalent to the rotating speed Vout2 of second reduction mechanism 20 (Vreal=Vout2=Vout1). Therefore, a route of first reduction mechanism 10 of the traction system transmits the rotational driving force from the drive shaft while making slippage between drive roller 41 and driven roller 51, and this gives a torque load on another route of second reduction mechanism 20, which transmits the rotational driving force via the engagement of drive gear 42 and driven gear 52.

As a result, this structure can ensure reliable engagement of drive gear 42 and driven gear 52 as compared to an ordinary structure composed only of second reduction mechanism 20 for transmitting the rotational driving force via the engagement of the gears, because a part of the load is borne by first reduction mechanism 10. Accordingly, this structure can abate meshing noises of the gears so as to further abate operating noises of the rotation drive unit.

Furthermore, the reliable engagement of drive gear 42 and driven gear 52 can help improve smooth transmission of the rotational driving force from drive gear 42 to driven gear 52. There is a certain amount of play margin normally provided in the engaged portion of the gears, which tends to cause variations in rotation of driven gear 33 and produce meshing noises attributable to vibrations at the engaged portion as well as distortion of the gears liable to occur if the rotational driving force is transmitted only via the engagement of the gears. According to the present invention, however, the embodied structure can abate the rotational variations and also the meshing noises due to the rotating vibrations since the load is impressed on the gears by first reduction mechanism 10 to ensure the positive engagement of the gears.

The prior impression of the load on the gears helps alleviate the variations in the rotating speed attributed to variations in the workload of the gears. These variations in the workload, if occur, often cause the gears to deform (distortion) to an extent corresponding to the workload. This leads to an upsizing of the gears by increasing their thicknesses and the like measures taken in order to increase stiffness of the gears and to avoid the deformation. Use of the excessively thick gears at a small workload tends to affect adversely to the positive engagement of the gears and result in undesired vibrations. In this exemplary embodiment, however, first reduction mechanism 10 can provide the thick gears with a proper amount of the workload to maintain the adequate engagement. It can thus make possible to reduce the variations in the rotating speed attributable to the variations in the workload while also achieving the robustness of the gears.

In the present invention, first reduction mechanism 10 and second reduction mechanism 20 illustrated above are not intended to define or limit specific structures thereof, but they can be of any structure of the conventional art selected as to be suitable for the intended application. For example, drive roller 41, drive gear 42, driven roller 51 and driven gear 52 can be formed of any known materials such as polymeric resins of various kinds (i.e., plastics), metals and the like. Likewise, the shapes and thicknesses of these rollers and gears are not specifically restrictive, and they can be designed as appropriate according to the required conditions such as a rotational driving force to be delivered, the type, size, torque, rotating speed, and the like characteristics of the rotationally driven members (i.e., photoconductor drums in this exemplary embodiment).

It is preferable here that driven roller 51, in particular, is so composed that at least its surface that comes in contact with a surface of drive roller 41 is made of a material having a coefficient of dynamic friction suitable for receiving the rotational driving force transmitted to it while making slippage on the surfaces of contact with the surface of drive roller 41 (hereinafter referred to for simplicity as “friction material”). Incidentally, a specific value of the coefficient of dynamic friction is not particularly definable, as such that the value shall be determined as appropriate according to various conditions such as a contact pressure between drive roller 41 and driven roller 51, a material used for drive roller 41, surface conditions of drive roller 41, and the like.

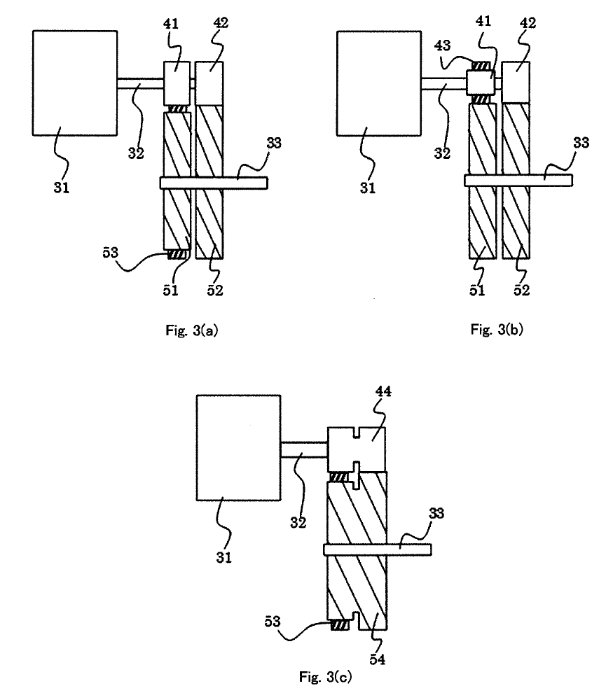

An elastic material can be named as an example suitable for the friction material. Specifically shown as a typical example is a structure comprising elastic annular member 53 attached to the outer circumference (i.e., roller surface) of driven roller 51, as shown in FIG. 3(a). In FIG. 3(a), drive roller 41 and drive gear 42 are shown as viewed from the side, whereas driven roller 51 and driven gear 52 are shown schematically as a sectional view.

By virtue of driven roller 51 provided with the friction material on the surface thereof, as shown, it becomes possible to maintain driven roller 51 in contact with drive roller 41 while relieving a thrust pressure of the contact properly between these rollers. It can thus transmit the rotational driving force from drive roller 41 to driven roller 51 while providing a desirable frictional force to maintain the contact with an adequate slippage between the surfaces of these rollers in first reduction mechanism 10.

Materials suitable for the above elastic material are not limited to any specific kind, as long as it has a self-retentive property with sufficient durability for transmission of the rotational driving force and an easily deformable elasticity to an externally applied force. Typical materials having the above physical properties include rubbers of various kinds.

Examples of such rubber materials include, but not limited to: natural rubber; synthetic diene rubber such as isoprene rubber, butadiene rubber, styrene-butadiene rubber, chloroprene rubber, acrylonitrile-butadiene rubber (nitrile rubber), etc.; synthetic non-diene rubber such as butyl rubber, ethylene propylene rubber, urethane rubber, silicone rubber, chlorosulfonate rubber, chlorinated polyethylene, acrylic rubber, epichlorohydrin rubber, fluorine rubber, etc. Although it is the normal practice to use only one kind selected from the rubber materials listed above, these rubber materials may be used in a form of a rubber alloy or a multi-layered structure by combining or laminating a plurality of the materials of different kinds. Specific examples of the multi-layered structure are not discussed here, except that one such example may be a double-layered structure comprising an inner layer made of a rubber material having effective impact resilience and an outer layer made of another rubber material of high coefficient of friction. In addition, the above rubber materials may be used in combination with any known additives.

According to the present exemplary embodiment, photoconductor drum 34 is shown as an example of a rotationally driven member used in the image forming apparatus of the electro-photographic printing system. In this case, it is particularly preferable to use a rubber material of superior ozone resistance such as hydrogen-added nitrile rubber (e.g., hydrogenated nitrile rubber, or H-NBR).

In the aforesaid example structure, although driven roller 51 is provided on its surface with an elastic material of annular shape, it is not intended to define or limit the present invention only to this structure. Instead, such elastic annular member 43 may be attached to the surface of drive roller 41, as shown in FIG. 3(b). Alternatively, the structure may be altered such that both driven roller 51 and drive roller 41 are provided on their respective surfaces with elastic annular member 53 and another elastic annular member 43 having different physical properties such as surface friction, elasticity, etc. that affect the condition of thrust contact. Or, the structure may even be so altered that at least one of driven roller 51 and drive roller 41 is made entirely of a solid elastic material.

In the present invention, first reduction mechanism 10 and second reduction mechanism 20 always operate in a pair. It is therefore practical that at least one of a pair consisting of drive roller 41 and drive gear 42 and another pair consisting of driven roller 51 and driven gear 52 is formed unitary into a single unit component. For example, drive roller 41 and drive gear 42 illustrated in any of FIG. 3(a) and FIG. 3(b) may be formed into a single unitary component of rotationally-drive motion transmitter 44, and driven roller 51 and driven gear 52 also illustrated in any of FIG. 3(a) and FIG. 3(b) may be formed into another single unitary component of rotationally-driven motion transmitter 54, as shown in FIG. 3(c).

In the case of using an elastic material to form the roller surface, it is more preferable according to this invention that elastic annular member 53 is attached to the outer circumference of driven roller 51 or the roller portion of rotationally-driven motion transmitter 54, as shown in FIG. 3(a) or FIG. 3(c). Because driven roller 51 generally has a larger diameter than that of drive roller 41, it is possible to reduce the frequency of use (i.e., repeated application of stresses) the elastic material is subjected to, when the elastic material is attached to the surface of driven roller 51 having the larger diameter. Accordingly, it can prolong the operating life of the rollers.

As described, the reduction mechanism according to the present invention is provided with a plurality of rotary shafts (i.e., drive shaft 32 and driven shaft 33) disposed in parallel to each other, the plurality of rotary shafts having rotational motion transmitters (i.e., drive roller 41, drive gear 42, driven roller 51 and driven gear 52, or rotationally-drive motion transmitter 44 and rotationally-driven motion transmitter 54) attached thereto in a manner concentric to their respective rotating axis, wherein each of the rotational motion transmitters constitute a reduction mechanism having a pair of the rotary shafts kept coupled with each other for transmitting the rotational driving force from one rotary shaft to the other rotary shaft at a reduced rotating speed. First reduction mechanism 10 and second reduction mechanism 20 are the two reduction mechanisms provided in this exemplary embodiment.

These two reduction mechanisms are designed to have different reduction ratios of the rotating speed, and the one mechanism (first reduction mechanism 10) having a larger reduction ratio than the other mechanism (second reduction mechanism 20) is so constructed that the rotational motion transmitters rotate while causing slippage on their surfaces of thrust contact to generate a braking effort. Accordingly, since this structure ensures the reliable engagement of the gears it can abate meshing noises at the engaged portion as well as operating noises in the rotation drive unit, while also reducing the rotational variations and noises of the driven shaft due to engagement of the gears.

The present invention can be embodied with more than two reduction mechanisms, as needless to mention. According to the present invention, it is not necessary for the first reduction mechanism to have only the larger reduction ratio than that of the second reduction mechanism, as discussed in this exemplary embodiment, as long as the reduction ratios are set differently between the first reduction mechanism and the second reduction mechanism. The present invention merely requires that the two reduction mechanisms are juxtaposed in parallel with each other, and that they have different reduction ratios, so that the rotating speed of the drive shaft can be transmitted accurately and reliably.

As described, the rotation drive unit of the present invention has a parent-child combination of the reduction mechanisms provided with a drive shaft and a driven shaft juxtaposed in parallel with each other, and a typical structure includes the following characteristic features.

That is, (1) the drive shaft is rotatably driven by the driving source (such as a motor or other power source), and (2) the drive shaft is provided with the drive roller attached concentrically to a rotating axis thereof in a rotatable manner, the driven shaft is provided with the driven roller also attached concentrically to a rotating axis thereof in a rotatable manner, and the drive roller and the driven roller are kept in thrust contact to each other to form the first reduction mechanism of tractional transmission system for transmitting the rotational driving force of the driving source from the drive shaft to the driven shaft by means of the tractional force.

Furthermore, (3) the drive shaft is provided with the drive gear attached concentrically to the rotating axis thereof in a rotatable manner, the driven shaft is provided with the driven gear also attached concentrically to the rotating axis thereof in a rotatable manner, and the drive gear and the driven gear are engaged with each other to form the second reduction mechanism of gear transmission system for transmitting the rotational driving force of the driving source from the drive shaft to the driven shaft by means of the gear engagement. Here, (4) the reduction ratio of the rotating speed of the first reduction mechanism under no load condition (i.e., when the first reduction mechanism is operated independently) is larger than the reduction ratio of the second reduction mechanism.

According to the foregoing structure, the rotating speed of the driven shaft rotated by the first reduction mechanism is set slower than the rotating speed if the driven shaft rotated by the second reduction mechanism. Since the first reduction mechanism transmits the rotational driving force by the frictional contact between the rollers, it rotates at the rotating speed equal to that of the second reduction mechanism while making slippage between the rollers. Accordingly, a route of the first reduction mechanism generates a braking effort when transmitting the rotational driving force from the drive shaft while making slippage between the rollers, and this exerts a torque load on another route of the second reduction mechanism of the gear transmission system. Since the first reduction mechanism transmits the rotational driving force while exerting the load upon the second reduction mechanism, it can provide a satisfactory and reliable speed-reducing operation. In addition this structure can also transmit the rotational driving force reliably and accurately even if it is equipped with a plurality of driven shafts coupled to single drive shaft as will be explained later.

Since the embodied structure enables the single driving source to drive two or more shafts, it can obviate the necessity of increasing the size of the drive system to drive the rotationally driven members. The structure can also obviate the necessity of increasing a number of the driving sources as well as a number of control circuits (i.e., drivers) associated with them, thereby realizing the rotation drive unit with low cost.

Furthermore, the load delivered from the drive shaft to the driven shafts through the engaged portions of the gears (i.e., second reduction mechanism) is supplemented by the tractional force of the rollers (i.e., first reduction mechanism), this structure ensures the reliable engagement of the gears as compared to the ordinary structure relying solely upon the gear transmission system. This structure can therefore abate the meshing noises of the gears as well as operating noises of the rotation drive unit, as well as the rotational variations and the related noises attributable to the engagement of the gears.

In addition to the rotation drive unit illustrated above, the present invention also encompasses the mechanism of speed reducing function, or the speed reduction unit.

The technical field to which the present invention applies is not particularly limited, but the invention can be used widely in many fields that require transmission of rotational driving force with speed-reducing function. The present invention is particularly advantageous when applied to a color image forming apparatus of the electro-photographic printing system, as will be discussed in the fourth exemplary embodiment. A typical color image forming apparatus is provided with a plurality of photoconductor drums to form a color image by forming and superimposing toner images of different colors. The above rotation drive unit, when used for rotationally driving the plurality of photoconductor drums, can achieve more adequate rotation of the individual photoconductor drums, so as to effectively avoid misregistration in colors (“banding” as called generally) attributable to the gear engagement among the photoconductor drums of various color images.

### Second Exemplary Embodiment

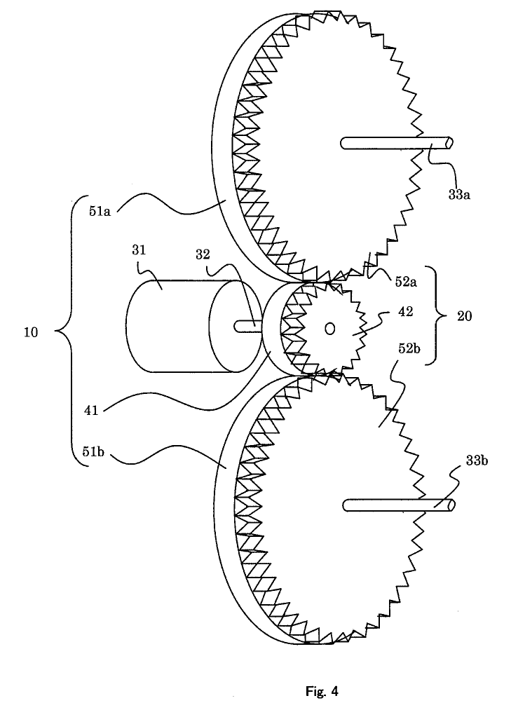

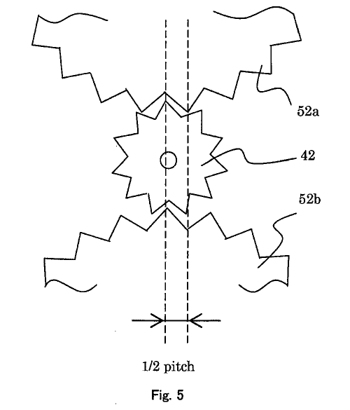

Description is provided hereinafter of another exemplary embodiment of the present invention with reference to FIG. 4 to FIG. 6. It should be understood that the exemplary embodiment described herein is not to be taken as restrictive, but the present invention may be embodied or practiced in still many other ways, and all changes which come within the meaning of the claims are intended to be embraced therein. For convenience's sake, like reference numerals are used throughout to designate components having substantially similar structures, functions and characteristics, as those of the first exemplary embodiment, and details of them will be omitted.

Although the rotation drive unit discussed in the above first exemplary embodiment is provided with one-to-one combination of drive shaft 32 coupled to one driven shaft 33, it is not intended to define or limit the present invention only to this structure. Instead, the structure may be so configured as to have a plurality of driven shafts 33 to be driven by single drive shaft 32.

Specifically, for example, first driven shaft 33a and second driven shaft 33b are provided in combination with single drive shaft 32, and first reduction mechanism 10 and second reduction mechanism 20 are disposed in their respective positions between drive shaft 32 and driven shaft 33a, and also between drive shaft 32 and driven shaft 33b, as shown in FIG. 4. In the example shown in FIG. 4, first driven shaft 33a carries first driven roller 51a and first driven gear 52a, and second driven shaft 33b carries second driven roller 51b and second driven gear 52b.

Among these rollers and gears, drive roller 41 attached to drive shaft 32 is in thrust contact with first driven roller 51a and second driven roller 51b. First driven roller 51a and second driven roller 51b are thus driven by a tractional force of drive roller 41 rotated by drive shaft 32, so as to transmit the rotational driving force of drive shaft 32 to first driven shaft 33a and second driven shaft 33b. As shown, drive roller 41 and driven roller 51a constitute a part of first reduction mechanism 10 interlocking between drive shaft 32 and first driven shaft 33a, and drive roller 41 and second driven roller 51b constitute the rest of first reduction mechanism 10 between drive shaft 32 and second driven shaft 33b.

The individual rollers are arranged in such a positional relation that drive roller 41 is disposed between first driven roller 51a and second driven roller 51b. Namely, first reduction mechanism 10 of this exemplary embodiment is made up of first driven roller 51a, drive roller 41 and second driven roller 51b that are in thrust contact with one another.

Among the above rollers and gears, drive gear 42 attached to drive shaft 32 engages with first driven gear 52a and second driven gear 52b. Drive gear 42 transmits its rotational motion to first driven gear 52a and second driven gear 52b via their engagements, thereby transmitting the rotational driving force of drive shaft 32 to first driven shaft 33a and second driven shaft 33b. Accordingly, drive gear 42 and first driven gear 52a constitute a part of second reduction mechanism 20 interlocking between drive shaft 32 and first driven shaft 33a, and drive gear 42 and second driven gear 52b constitute the rest of second reduction mechanism 20 between drive shaft 32 and second driven shaft 33b.

In this invention, first reduction mechanism 10 transmits the rotational driving force by the tractional force between drive roller 41 and driven roller 51a, and also between drive roller 41 and driven roller 51b while making slippage between them, since the rotating speed delivered through first reduction mechanism 10 is slower than the rotating speed delivered through second reduction mechanism 20, as has been described in the first exemplary embodiment. In this operation, second reduction mechanism 20 employing the engagement of gears serves as a “primary function” of the speed-reduction transmission system, whereas first reduction mechanism 10 employing the tractional force serves as a “braking function” of the speed-reduction transmission system.

This structure can stabilize the load borne by second reduction mechanism 20 of the “primary function”, and it therefore helps abate meshing noises as well as rotational variations attributed to the engagement of the gears. In addition, because of the dual transmission system comprising first reduction mechanism 10 of the “braking function” exerting upon second reduction mechanism 20 of the “primary Function” when transmitting the rotational driving force, the invented structure can deliver the rotational driving force of motor 31 reliably and accurately even when the plurality of driven shafts 33 (e.g., first driven shaft 33a and second driven shaft 33b) are coupled to the single drive shaft 32, as illustrated in this exemplary embodiment.

This structure enabling the single drive shaft 32 to rotationally drive the plurality of driven shafts can provide an advantage of eliminating the need of employing extra motors 31 of the same number as that of driven shafts, thereby making it possible to simplify the structure and reduce a size of the rotation drive unit (or speed reduction unit), and the manufacturing cost of the same since it does not require additional control circuits (i.e., drivers) otherwise needed for the extra motors 31.

In the structure of this exemplary embodiment, in which the two shafts, or first driven shaft 33a and second driven shaft 33b, are driven by the single drive shaft 32, it is preferable that first driven gear 52a and second driven gear 52b are arranged across drive gear 42 in a manner that they engage with a difference in phase of half a working pitch of the gear teeth with respect to each other, as shown in FIG. 5.

In other words, there is a difference in phase of half the working pitch of the gear teeth between first driven gear 52a attached to first driven shaft 33a and second driven gear 52b attached to second driven shaft 33b, according to this structure. This arrangement makes possible to cancel out changes in torque exerted on engaged portions of drive gear 42 on drive shaft 32 engaged with first driven gear 52a attached to drive shaft 33a and second driven gear 52b attached to drive shaft 33b. As a result, this structure can even out the changes in the torque due to the engagement of the gears, and thereby it can reduce variations of the rotational motion transmitted through first driven shaft 33a and second driven shaft 33b.

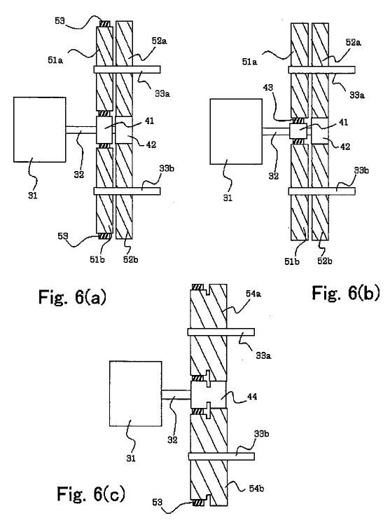

According to this exemplary embodiment, the rotation drive unit can be formed into a variety of configurations like those of the first exemplary embodiment, such as: first driven roller 51a and second driven roller 51b may be provided with elastic annular member 53 on each of their surfaces that are in contact with drive roller 41, as shown in FIG. 6(a); or elastic annular member 43 may instead be attached to the surface of drive roller 41, as shown in FIG. 6(b); first driven roller 51a and second driven roller 51b as well as drive roller 41 may all be provided on their respective surfaces with elastic annular members 53 and another elastic annular member 43 having different physical properties (e.g., surface friction, elasticity, etc. that affect the condition of the thrust contact), though not shown in the figures; at least one of first driven roller 51a, second driven roller 51b and drive roller 41 may be made entirely of a single elastic material; or drive roller 41 and drive gear 42 may be formed into a single unitary component constituting rotationally-drive motion transmitter 44, first driven roller 51a and first driven gear 52a into another single unitary component constituting first rotationally-driven motion transmitter 54a, and second driven roller 51b and second driven gear 52b into still another single unitary component constituting second rotationally-driven motion transmitter 54b, as shown in FIG. 6(c).

In the structure provided with the plurality of driven shafts, as described in this present exemplary embodiment, it is preferable that a same single molding die (i.e., die assembly) is used to form both first driven gear 52a and second driven gear 52b. It is further preferable, as shown in FIG. 6(c), that the individual pairs of the driven roller and the driven gear are formed unitary to compose first rotationally-driven motion transmitter 54a and second rotationally-driven motion transmitter 54b of unit components.

In the above structure, when first driven roller 51a and second driven roller 51b having a comparatively larger diameter than the corresponding driven gears are formed with a same single molding die to compose the reduction mechanisms, these identically shaped driven rollers make possible to equalize deviations in distances from the rotational axes to the pitch circles between first driven shaft 34a and second driven shaft 33b over their full rotating cycles. It is also possible to unitary form the individual combinations of the driven rollers and the driven gears as unit components and use them in the same fashion as first rotationally-driven motion transmitter 54a and second rotationally-driven motion transmitter 54b, so as to reduce a number of the components of the rotation drive unit (i.e., speed reduction unit) as well as a number of the assembling steps, thereby optimizing the process of manufacturing products.

Although this exemplary embodiment illustrates the structure having two driven shafts coupled to a single drive shaft, this is not intended to define or limit the present invention only to the above embodiment. The structure can be so configured as to have three or driven shafts driven by the single drive shaft. In consideration of the function of the rotation drive unit, or the speed reduction unit in its entirety, the invented structure may be provided with a plurality of drive shafts and a plurality of driven shafts coupled with each of the drive shaft.

### Third Exemplary Embodiment

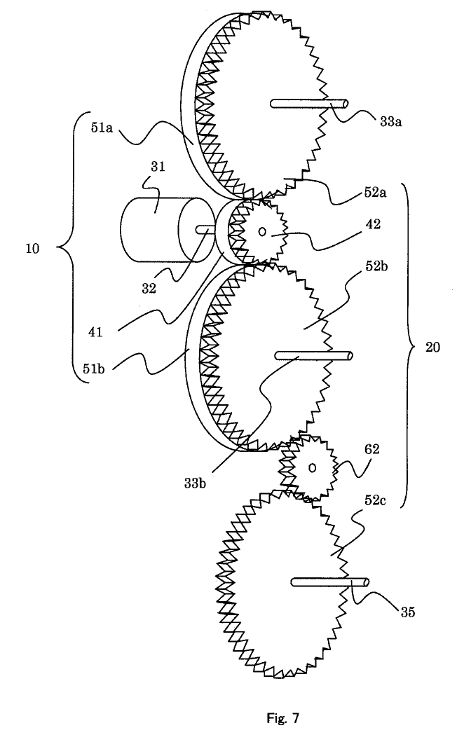

Description is provided hereinafter of another exemplary embodiment of the present invention with reference to FIG. 7 to FIG. 9. It should be understood that the exemplary embodiment described below is not to be taken as restrictive, but the invention may be embodied or practiced in still many other ways, and all changes which come within the meaning of the claims are intended to be embraced therein. Like reference numerals are used throughout to designate components having substantially similar structures, functions and characteristics as those of the first and second exemplary embodiments, and details of them will be omitted.

Giving a definition of “directly driven shaft” for the previously discussed driven shaft 33 (in the first exemplary embodiment), first driven shaft 33a or second driven shaft 33b (in the second exemplary embodiment) that is driven directly and constitutes first reduction mechanism 10 and second reduction mechanism 20 in combination with drive shaft 32, then this exemplary embodiment is characterized by further having an “indirectly driven shaft”, which is driven indirectly by the rotational driving force of drive shaft 32 via a driven gear coupled to the directly driven shaft.

More specifically, a rotation drive unit of this exemplary embodiment is provided with an indirectly driven shaft defining third driven shaft 35, as shown in FIG. 7, in addition to two directly driven shafts (i.e., first driven shaft 33a and second driven shaft 33b) all coupled to single drive shaft 32 in a similar manner as the second exemplary embodiment. Third driven shaft 35 has third driven gear 52c attached thereto, and idle gear (or, intermediate gear) 62 is disposed between third driven gear 52c and second driven gear 52b on second driven shaft 33b in engagement therewith.

As described, this structure has third driven shaft 35 designed to be driven by idle gear 62 coupled to second driven shaft 33b, thereby enabling single motor 31 to drive three driven shafts. This exemplary embodiment can hence achieve further reduction in size of the rotation drive unit (or speed reduction unit). Since this structure eliminates the need of employing extra motors of the same number as that of the driven shafts, it does not require additional control circuits (i.e., drivers) otherwise needed for the extra motors 31, and reduces the manufacturing cost of the rotation drive unit (or speed reduction unit).

In the above rotation drive unit, first driven roller 51a, drive roller 41 and second driven roller 51b constitute first reduction mechanism 10, and first driven gear 52a, drive gear 42, second driven gear 52b, idle gear 62 and third driven gear 52c constitute second reduction mechanism 20.

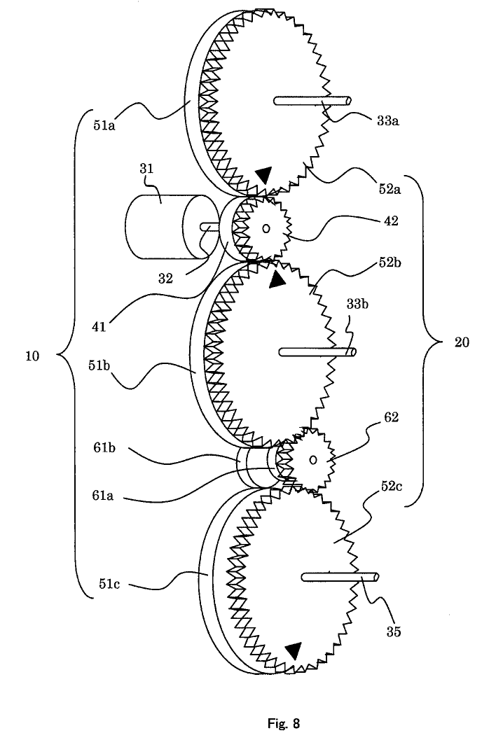

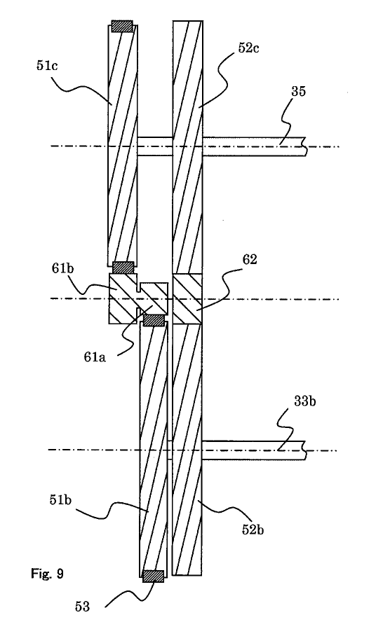

Furthermore, this exemplary embodiment may be so modified that third driven roller 51c is attached to third driven shaft 35, and idle rollers (or, intermediate rollers) 61a and 61b are connected in parallel with idle gear 62, as shown in FIG. 8. In other words, idle rollers 61a and 61b may be provided in a concentrically rotatable manner with idle gear 62. These idle rollers 61a and 61b are so disposed that idle roller 61a is in contact with second driven roller 51b, and idle roller 61b is in contact with third driven roller 51c, as shown in FIG. 9. Second driven roller 51b and third driven roller 51c are disposed in parallel to each other with their rotating planes shifted in the axial direction to avoid the peripheral roller surfaces from contacting with each other.

It is desirable to unitary form idle rollers 61a and 61b into a single unit, as shown in FIG. 9, in the light of reducing number of components. Second driven roller 51b and third driven roller 51c are provided on their peripheral surfaces with the same elastic annular members 53 as illustrated earlier in the first and second exemplary embodiments. This structure is suitable for reliable transmission of the rotational driving force from second driven roller 51b to third driven roller 51c since they can rotate with an adequate frictional force between their contacting surfaces.

According to this structure, the rotational driving force of third driven shaft 35 is transmitted from second driven roller 51b attached to second driven shaft 33b to third driven roller 51c attached to third driven shaft 35 by way of the rotatable contact with idle rollers 61a and 61b. This structure delivers the rotational driving force from second driven shaft 33b to third driven shaft 35 through idle rollers 61a and 61b in addition to idle gear 62. As a result, it can achieve smoother and more accurate transmission of the rotational driving force to third driven shaft 35.

In other words, the rotation drive unit shown in FIG. 8 has second reduction mechanism 20 of the same configuration as that shown in FIG. 7, comprising first driven gear 52c, drive gear 42, second driven gear 52b, idle gear 62 and third driven gear 52c, but first reduction mechanism 10 of different configuration comprising first driven roller 51a, drive roller 41, second driven roller 51b, idle rollers 61a and 62b, and third driven roller 51c. Like the rotation drive units of the first and the second exemplary embodiments, it is desirable that the reduction ratio of rotating speed of first reduction mechanism 10 is set to be larger than the reduction ratio of second reduction mechanism 20 when compared on the assumption that they are operated independently for transmitting the rotational driving force of drive shaft 32 to driven shaft 33.

When a load is imposed on third driven shaft 35, first reduction mechanism 10 of the tractional transmission system having idle rollers 61a and 61b causes slippage on the rollers surfaces, which lowers the rotating speed and makes the reduction ratio of first reduction mechanism 10 equal to that of second reduction mechanism 20 having the gear transmission system. As a result, this rotation drive unit can provide the novel function and advantageous effect of the reduction mechanism of this invention for not only first driven shaft 33a and second driven shaft 33b but also third driven shaft 35, since the load is borne and delivered through both the gear transmission system and the tractional transmission system.

In this structure of first reduction mechanism 10 and second reduction mechanism 20, the rotating speed is not reduced in the transmission of the driving force from second driven shaft 33b to third driven shaft 35. However, both mechanisms of this exemplary embodiment are regarded as the reduction mechanisms, taking into account the entire system consisting of the plurality of interlocked rollers and gears, since the rotating speed at third driven shaft 35 is obviously reduced from that of drive shaft 32. On the other hand, first reduction mechanism 10 and second reduction mechanism 20 of this invention may be referred to as first transmission mechanism 10 and second transmission mechanism 20 respectively in consideration of the fact that they do not reduce the rotating speed in certain parts thereof.

According to this exemplary embodiment, it is preferable as in the case of the second exemplary embodiment that at least one of first driven roller 51a, second driven roller 51b, idle rollers 61a and 61b and third driven roller 51c has its roller surface formed of a frictional material such as an elastic material, although not shown in the figure. It is more preferable that the surfaces of all of the above rollers are made of such frictional material (refer to FIG. 3(a) and FIG. 6(a)). It is also preferable that at lease one of these rollers are formed unitary with its corresponding gear into a single unit of rotationally-driven motion transmitter, and it is even more preferable that all of these rollers are unitary formed with their corresponding gears (FIG. 3(c) and FIG. 6(c)).

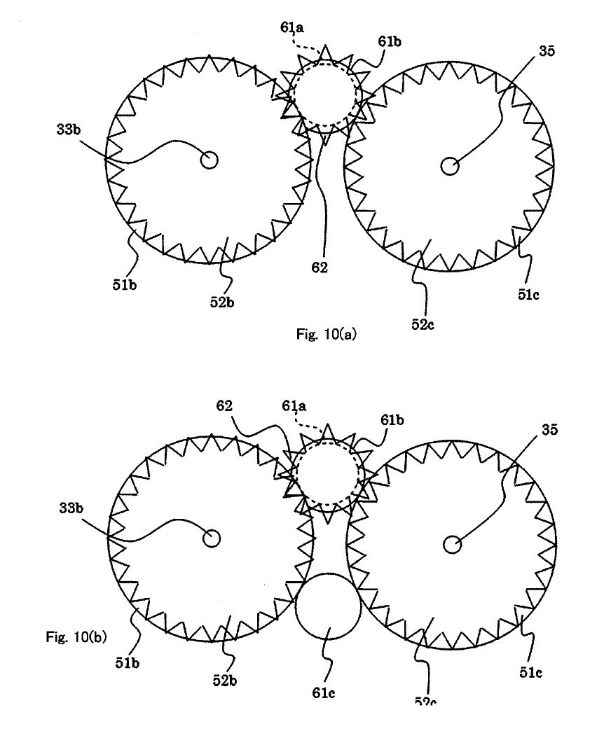

In this exemplary embodiment, as illustrated in FIG. 8, FIG. 9 and FIG. 10(a), second driven roller 51b is in contact with idle roller 61a (shown by dotted line in FIG. 10(a)), third driven roller 51c is in contact with idle roller 61b (shown by solid line in FIG. 10(a)), and idle gear 62 is in engagement with both second driven gear 52b and third driven gear 52c in a position therebetween. However, this is not intended to define or limit the present invention only to the above embodiment, and this system may further be provided with another idle gear 61c as shown in FIG. 10(b).

In the exemplary structure shown in FIG. 10(b), idle roller 61c is disposed at a position generally symmetrical to the position where idle rollers 61a, 61b and idle gear 62 are located with respect to a phantom line connecting second driven shaft 33b and third driven shaft 35. Addition of these intermediate rollers between second driven roller 51b and third driven roller 51c can achieve reliable and accurate transmission of the rotational driving force from the directly driven shaft (i.e., second driven shaft 33b) to the indirectly driven shaft (i.e., third driven shaft 35).

The structure of idle roller 61c is not specifically limited to that illustrated above, but it may have a configuration similar to the combination of idle rollers 61a and 61b, consisting of two different rollers conjugated side-by-side with their planes shifted in the axial direction in a manner to correspond with second driven roller 51b and third driven roller 51c (refer to FIG. 9). Alternatively, idle roller 61c may be a single piece of roller having a width large enough to contact with both second driven roller 51b and third driven roller 51c, the rotating planes of which are shifted.

In addition, it is preferable in this exemplary embodiment that at least first driven gear 52a, second driven gear 52b and third driven gear 52c are formed by using a same single molding die, and that the molding die is provided in its cavity with a marking for indication of a reference position of rotational phase to be inscribed in these gears during the molding process.

When attention is paid only to the gears in the structures illustrated in FIGS. 7, 8 and 11 of this exemplary embodiment, the plurality of gears are engaged with each other to form an interlocked gear train. This gear train has a drawback that phase differences occur among the gears when they rotate due to small differences in their shapes attributed to the process of molding. There also exist differences in the peripheral speeds of the individual gears attributed to deviations in their pitch radii due to variations in the shapes and decentering thereof. In view of the above drawbacks, therefore, it is especially desirable in this exemplary embodiment to use the same single molding die to form all of the three driven gears (i.e., first driven gear 52a, second driven gear 52b and third driven gear 52c) that relate directly to the rotational motion of the photoconductor drums, and to compose a gear train by assembling the gears in a manner to align their engaged portions in the same orientations.

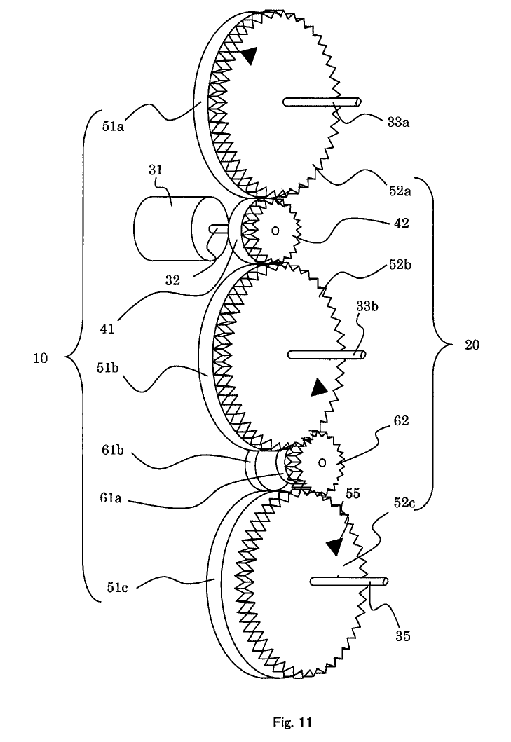

A more specific example is a molding die having a cavity so fabricated that it forms a triangularly shaped marking 55 on every surface of first driven gear 52a, second driven gear 52b and third driven gear 52c as shown in FIG. 11. It becomes possible to align the engaged portions of first driven gear 52a, second driven gear 52b and third driven gear 52c by using markings 55 as their reference positions, as shown in FIG. 11, when assembling them into a gear train of the rotation drive unit. This can thus make first driven shaft 33a, second driven shaft 33b and third driven shaft 33c into synchronization in their variations in the peripheral speeds over their full rotation cycles, and reduce differences in the relative speeds among the individual driven shafts.

Here, the shape of marking 55 is not necessarily limited to the triangular shape shown in FIG. 11, but it can be of any other shape. However, in consideration of the ease of aligning the phases of the gears, it is desirable that marking 55 has a shape that clearly indicates a direction of the reference position, such as a triangle, an arrow, and the like. The method of forming the marking is not particularly limited either, and that it can be formed into a concave shape or a convex shape on the gear surface. Alternatively, marking 55 may be made with a seal or painting applied to the gear surface as long as the task of marking can be carried out steadily and consistently.

In the case where the gears and the rollers are prepared separately as independent components, it is desirable that the rollers are also aligned of their phases in the same manner as the gears. In consideration of this burden, it is therefore more preferable to form each roller-and-gear combination into a unit component of rotationally driven transmitter (refer to FIG. 3(a) and FIG. 6(c)) so that alignment of the engaged portions of the gears can also accomplish the alignment of the contact portions of the rollers at the same time.

In the embodiment illustrated above, although the rotational driving force to third driven shaft 35 is transmitted from second driven shaft 33b through idle gear 62 and idle rollers 61a, 61b and 61c, this is not intended to define or limit the present invention only to the above embodiment. Instead, the rotational driving force to third driven shaft 35 can be transmitted from first driven shaft 33a.

### Fourth Exemplary Embodiment

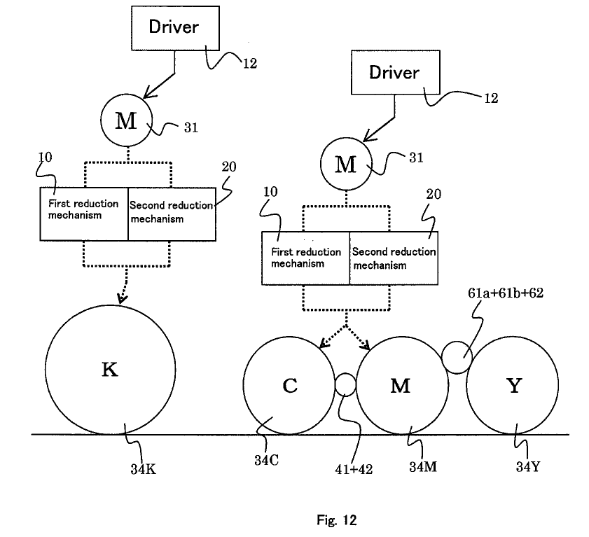

With reference to FIG. 12, description provided hereinafter pertains to another exemplary embodiment of the present invention. It should be understood that the exemplary embodiment described below is not to be taken as restrictive, but the invention may be embodied or practiced in still many other ways, and all changes which come within the meaning of the claims are intended to be embraced therein. Like reference numerals are used throughout to designate components having substantially similar structures or practically same functions and characteristics as those of the first through third exemplary embodiments, and details of them will be skipped.

The technical field of the rotation drive unit (i.e., speed reduction unit) of the present invention is not specifically limited, and this invention is applicable to a variety of products in many fields. In particular, the present invention is most advantageous when applied to a color image forming apparatus of a type using the electro-photographic printing system.

According to this exemplary embodiment, an image forming apparatus is provided with any of the rotation drive units discussed in the first to third exemplary embodiments for use as a driving means to rotate photoconductor drums. In the image forming apparatus of the electro-photographic printing system, an electrostatic latent image is formed on a surface of the photoconductor drum by an exposure unit, and toner particles are then adhered onto the electrostatic latent image to thereby form a toner image on the surface of the photoconductor drum. The resulting toner image is transferred and fixed to a recording medium such as a sheet of paper either directly or indirectly via an intermediate transfer medium.

A color image forming apparatus uses a plurality of colored toners whereas a commonly available image forming apparatus uses only black toner. Accordingly, the color image forming apparatus for producing a plurality of color images is required to have the same number of photoconductor drums corresponding to the individual colors. A typical color image forming apparatus is provided with photoconductor drum 34K used to form a toner image of black color, and three photoconductor drums used to form toner images of chromatic color, that are photoconductor drum 34Y for a yellow color image, photoconductor drum 34M for a magenta color image and photoconductor drum 34C for a cyan color image, as shown in FIG. 12.

As an example, the color image forming apparatus of this exemplary embodiment may be provided with a rotation drive unit having single driven shaft 33 corresponding to single drive shaft 32 as illustrated in the first exemplary embodiment, for rotationally driving the photoconductor drum 34K, and another rotation drive unit having three driven shafts (i.e., first driven shaft 33a, second driven shaft 33b and third driven shaft 33c) corresponding to single drive shaft 32 as illustrated in the third exemplary embodiment, for rotationally driving the three photoconductor drums 34Y, 34M and 34C for yellow color image, magenta color image and cyan color image respectively. Incidentally, a color image forming apparatus having a plurality of photoconductor drums connected in series such as the one shown in FIG. 12 is generally known as a tandem-type color image forming apparatus.

The color image forming apparatus produces a color image by forming and superimposing toner images of four colors, or black (K), cyan (C), magenta (M) and yellow (Y). Therefore, quality of the image formed on the recording medium is impaired if misregistration occurs in any color of the toner image. Here, the accuracy of rotation of these photoconductor drums has a significant effect on the registration in color of the toner image.

It is for this reason that this exemplary embodiment includes the rotation drive unit of the third exemplary embodiment equipped with a single driving source (i.e., motor 31) for rotationally driving at least three photoconductor drums 34Y, 34M and 34C for chromatic toner images. This embodiment can reduce an overall size of the image forming apparatus even when motor 31 of a larger size is used to increase the driving power, since it eliminates the need to provide three motors 31. This embodiment can also reduce the cost of manufacturing the image forming apparatus since it does not require extra control circuits (i.e., drivers 12) otherwise needed to drive the additional motors.

In addition, a gear train consisting of gear-and-roller combinations formed unitary with the same single molding die and assembled with their phases aligned in the same orientation (refer to FIG. 11) makes it possible to bring differences in variations of the rotating speeds among the three photoconductor drums into generally an equal level over their full rotating cycle. As a result, this embodiment can significantly reduce the differences in the rotating speeds among the photoconductor drums, so as to effectively avoid misregistration in the colors during the process of registering the individual toner images.

This embodiment can also achieve a further reduction of noise during the image forming process when the rotation drive unit of the first exemplary embodiment is used for driving photoconductor drum 34K for black image since it abates meshing noises of the gears in the image forming apparatus. In all, use of the rotation drive unit can effectively obviate misregistration in color during the process of registering the toner images of chromatic colors with the black image because it reduces variations in the rotating speed of photoconductor drum 34K attributable to engagement of the gears.

Although the exemplary embodiment discussed here is not intended to limit any specific order of positioning the three photoconductor drums for the chromic color images, it is preferable that the two photoconductor drums 34C and 34M for toner images of relatively prominent colors, i.e., cyan and magenta, are rotated by the directly driven shafts, or first driven shaft 33a and second driven shaft 33b, and photoconductor drum 34Y for toner image of yellow color is rotated by the indirectly driven shaft, or third driven shaft 35. This arrangement of the photoconductor drums provides an advantage of easing the designing task of the image forming apparatus for the following reason. That is, the photoconductor drum rotated by the indirectly driven shaft is more liable to cause misregistration of the image it produce as compared to the other photoconductor drums rotated by the directly driven shafts, but the yellow image produced by the drum connected to the indirectly driven shaft is not significantly noticeable even if such misregistration or banding occurs.

As described, the rotation drive unit according to the present invention includes a speed reduction mechanism provided with a drive shaft and a driven shaft disposed in parallel to each other, wherein the drive shaft has a drive roller and a drive gear concentrically attached thereto, the driven shaft has a driven roller and a driven gear concentrically attached thereto, the drive roller and the driven roller are rotatably in contact with each other to compose a first reduction mechanism for transmitting the rotational driving force of the drive shaft to the driven shaft, the drive gear and the driven gear are rotatably engaged to compose a second reduction mechanism for transmitting the rotational driving force of the drive shaft to the driven shaft, and a reduction ratio of rotating speed of the first reduction mechanism is set to be different from a reduction ratio of rotating speed of the second reduction mechanism when the first reduction mechanism and the second reduction mechanism are compared on an assumption of transmitting the rotational driving force independently from the drive shaft to the driven shaft.

It is particularly preferable that the reduction ratio of rotating speed of the first reduction mechanism is designed to be larger than the reduction ratio of the second reduction mechanism.

In the rotation drive unit of this structure, it is preferable that the plurality of driven shafts are driven by the single drive shaft, and the unit includes both the first reduction mechanism and the second reduction mechanism between the single drive shaft and the individual driven shafts. It is further preferable that driven gears provided on the plurality of driven shafts in the second reduction mechanism are so arranged that they maintain a difference in phase of half a working pitch of the gear teeth at their positions of engagement.

When the driven shafts in the first reduction mechanism and the second reduction mechanism are named “directly driven shafts” as they are driven directly by the drive shaft, then it is preferable that this rotation drive unit is further provided with an indirectly driven shaft that receives the rotational driving force of the drive shaft indirectly from one of the driven gears attached to the directly driven shafts. It is more preferable that the indirectly driven shaft is provided with a driven gear, and that the driven gear on the indirectly driven shaft is engaged with one of the driven gears attached to the directly driven shafts through an idle gear disposed between them.

It is still preferable that the indirectly driven shaft is also provided with a driven roller, and an idle roller additionally disposed next to the idle gear, and that the driven roller on the directly driven shaft and the driven roller on the indirectly driven shaft are rotatably in contact with the idle roller for transmitting the rotational driving force of the drive shaft. When the reduction mechanism made up of the driven rollers on the directly driven shafts, the idle roller and the driven roller on the indirectly driven roller is named “first reduction mechanism”, and another reduction mechanism made up of the driven gears on the directly driven shafts, the idle gear and the driven gear on the indirectly driven shaft is named “second reduction mechanism”, then it is particularly preferable that a reduction ratio of rotating speed of the first reduction mechanism is designed to be larger than a reduction ratio of the second reduction mechanism when the first reduction mechanism and the second reduction mechanism are compared on an assumption of transmitting the rotational driving force independently from the drive shaft to the driven shaft.

In addition, it is preferable that each combination of the driven roller and the driven gear is formed unitary into one unit component.

Furthermore, it is preferable in this rotation drive unit that all of the driven gears attached to the plurality of driven shafts are formed by using one and same molding die. In addition, it is especially preferable that the driven gears formed with the same molding die are assembled into a gear train with their pitch radii aligned in the same orientation at the portions of engagement.

In this rotation drive unit, it is preferable that the driven rollers are made of an elastic material at least around their peripheral surfaces that come in contact with other rollers, such as elastic annular members made of an elastic material attached to the surfaces. Rubber is a preferable example of such elastic material, and particularly preferable rubber materials include a hydrogen-added nitrile rubber (e.g., hydrogenated nitrile rubber, or H-NBR).

The speed reduction unit of the present invention comprises a plurality of rotary shafts disposed in parallel to each other, and a plurality of rotational motion transmitters provided concentrically on each of the plurality of rotary shafts, wherein each of the plurality of rotational motion transmitters provided on one of the rotary shafts is rotatably coupled to a corresponding one of the rotational motion transmitters on another rotary shaft to compose each of a plurality of reduction mechanisms for transmitting the rotational driving force at a reduced speed from the one rotary shaft to the another rotary shaft, and further wherein the plurality of reduction mechanisms have different reduction ratios of rotating speed, and all of the reduction mechanisms other than one having the largest reduction ratio transmit the rotational driving force while causing slippage amongst the rotational motion transmitters at their contacting surfaces.

The image forming apparatus according to the present invention is provided with any of the rotation drive unit of the aforesaid structure and the rotation drive unit having the speed reduction mechanism of the aforesaid structure as a rotation drive means for rotating the photoconductor drums.

The image forming apparatus of the present invention is preferably provided with a plurality of photoconductor drums adapted to form toner images of different colors, and the plurality of photoconductor drums comprise a photoconductor drum for forming a black toner image and a plurality of photoconductor drums for forming chromatic toner images. The photoconductor drums for chromatic toner images are adapted to be driven by the rotation drive means equipped with a single driving source. It is still more preferable that the plurality of photoconductor drums for chromatic toner images consist of three photoconductor drums, each forming one of toner images of yellow, magenta and cyan colors.

### Fifth Exemplary Embodiment

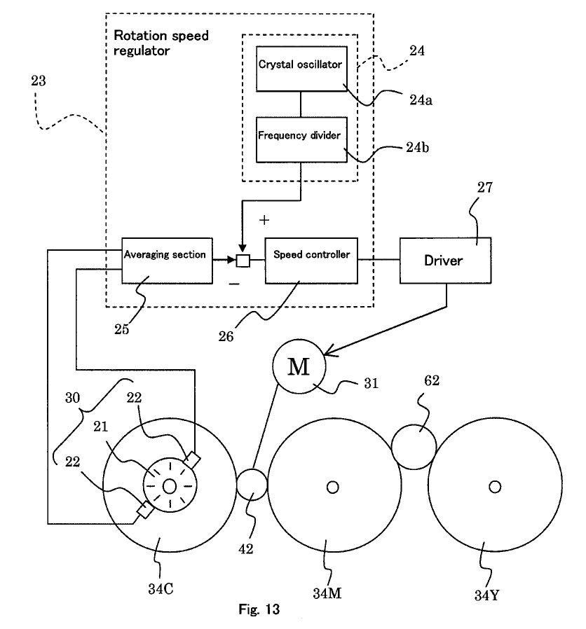

Referring to FIG. 13 to FIG. 15, description is provided hereinafter of still another exemplary embodiment of the present invention. It should be understood that the exemplary embodiment described below is not to be taken as restrictive, but the invention may be embodied or practiced in still many other ways, and all changes which come within the meaning of the claims are intended to be embraced therein.

A drive unit of the present invention is advantageous when employed in an image forming apparatus of a type using the electro-photographic printing system. Specifically, the drive unit is well suited for a color image forming apparatus provided with three photoconductor drums for forming chromatic color images, i.e., photoconductor drum 34Y for yellow color image, photoconductor drum 34M for magenta color image and photoconductor drum 34C for cyan color image, as shown in FIG. 13. These photoconductor drums for chromatic images are rotatably driven by single motor (or driving source) 31 and a gear train made up of a plurality of gears (not shown in FIG. 13). Accordingly, these three photoconductor drums for chromatic images have the same diameter, and are ganged together for being driven rotatably by a rotational driving force generated by the same driving source.

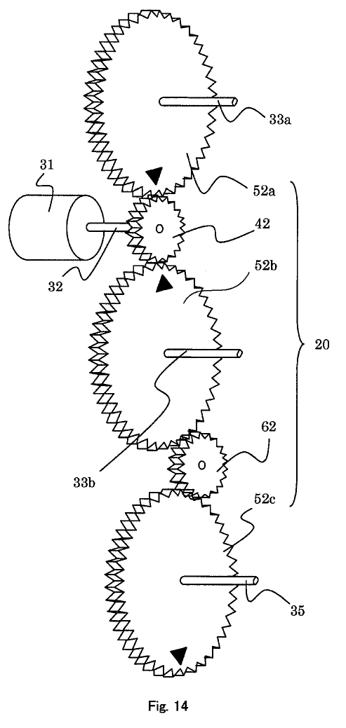

The gear train for rotatably driving these three photoconductor drums for chromatic images includes driven gears formed with a same single molding die. These driven gears are attached individually to drive shafts of photoconductor drum 34Y for yellow image, photoconductor drum 34M for magenta image and photoconductor drum 34C for cyan image, and assembled into single gear train 72, as shown in FIG. 14, in a manner so that all the driven gears are aligned of their pitch radii in the same orientation at their engaged portions, with drive gear 42 and intermediate gear 62 disposed between the adjoining driven gears, as will be described later. For convenience's sake, the above rotation driving mechanism comprising the plurality of identical gears, the drive shafts attached individually to the center of the gears, and assembled with the single driving source in a rotatable manner is referred to as “plural-shaft driving system”.

According to the structure shown in FIG. 14, the plural-shaft driving system has three driven shafts, namely first driven shaft 33a, second driven shaft 33b and third driven shaft 35 in communication with single driven shaft 32 linked to a driving source of motor 31, and the three driven shafts are connected to and function as driven shafts of the photoconductor drums for chromatic images. Drive shaft 32 is provided with drive gear 42, and first driven shaft 33a, second driven shaft 33b and third driven shaft 35 are provided with first driven gear 52a, second driven gear 52b and third driven gear 52c respectively as their corresponding driven gears. First driven gear 52a and second driven gear 52b are engaged directly with drive gear 42, and second driven gear 52b and third driven gear 52c are coupled to each other with idle gear 62 disposed between them. In this exemplary embodiment, drive gear 42 and idle gear 62 correspond to the “intermediate gears” discussed in the first exemplary embodiment. It should be noted, however, that all gears disposed between the adjoining driven gears are included in the definition of intermediate gears, beside drive gear 42 and idle gear 62.

At least all of the driven gears are formed by using the same molding die, although the described embodiment is not meant to restrict any specific structure of the individual gears that constitute gear train 72. The gears can be formed of any material without specific limitations, such as polymeric resins and metals of various kinds, or other known materials. A method of molding the gears is not particularly limited as long as the same molding die is used. For example, gears formed of a polyacetal resin by injection molding with the same molding die are suitable for this application since the polyacetal resin has beneficial properties, such as smooth sidable surfaces, excellent fatigue resistance, and relatively low cost. For the above reasons, this material is used commonly for many types of gears for image forming apparatuses. However, there are many kinds of polymeric resins that are also suitable other than polyacetal resins, as needless to note.

First driven shaft 33a and second driven shaft 33b are defined as “directly driven shafts” since the rotational driving force is transmitted to them directly from drive shaft 32. On the other hand, third driven shaft 35 is defined as “indirectly driven shaft” since the rotational driving force is transmitted to it from second driven shaft 33b via idle gear 62.

As described, the drive unit of this exemplary embodiment is provided with the two directly driven shafts (i.e., first driven shaft 33a and second driven shaft 33b) that receive the rotational driving force directly from drive shaft 32, and the indirectly driven shaft (i.e., third driven shaft 35) that is driven by idle gear 62 coupled to second driven shaft 33b. This enables single motor 31 to drive three driven shafts. This exemplary embodiment can hence achieve further reduction in size of the drive unit. Since this structure eliminates the need of employing extra motors of the same number as that of the driven shafts, it does not require additional control circuits (i.e., drivers) otherwise needed for the extra motors 31, and reduces the manufacturing cost of the drive unit.

In addition, this invention is characterized by having first driven gear 52a, second driven gear 52b and third driven gear 52c formed by using the same single molding die, and that the molding die is provided in its cavity with a marking for indication of a reference position of rotational phase to be inscribed in the gears during the molding process. In an example shown in FIG. 14, a cavity inside the molding die is so fabricated that it forms a triangularly shaped marking 55 on every surface of first driven gear 52a, second driven gear 52b and third driven gear 52c. It is desirable that the molding die is thoroughly examine for an angular position where a pitch radius of gear teeth becomes largest when making the molding die for the gear, and marking 55 is fabricated in a position inside the molding die corresponding to that position. Although the molding die normally bears many variations in the shape of gear teeth, pitch radius due to decentering, etc., it is desirable to fabricate marking 55 in a position corresponding to a part of pitch circle having the largest pitch radius.

It becomes possible with marking 55 to align the engaged portions of first driven gear 52a, second driven gear 52b and third driven gear 52c as shown in FIG. 14 when assembling them into a gear train of the rotation drive unit.

Here, the shape of marking 55 is not necessarily limited to the triangular shape shown in FIG. 14, but it can be of any other shape. However, in consideration of the ease of aligning the phases of the gears, it is desirable that marking 55 has a shape that clearly indicates a direction of the reference position, such as a triangle, an arrow, and the like. The method of forming the marking is not particularly limited either, and that it can be formed into a concave shape or a convex shape on the gear surface. Alternatively, marking 55 may be made with a seal or painting applied to the gear surface as long as the process of marking can be carried out steadily and consistently.

As described, the present exemplary embodiment illustrates the drive unit having the plural-shaft driving system wherein all three photoconductor drums for chromatic images are driven by a single motor. According to the present invention, one of these three photoconductor drums for chromatic images, or the photoconductor drum for cyan image in the case of this exemplary embodiment, is provided with pulse plate 21 mounted to the rotary shaft (i.e., driven shaft).

Pulse plate 21 is a circular plate concentrical to the rotary shaft. The structure of pulse plate 21 is not particularly restrictive, and many configurations are applicable such as one using an optical method or a magnetic method, as long as it has markings formed into a circular pattern at equal intervals. A representative structure adopted in this exemplary embodiment has a plurality of radial slits formed into a circular pattern at predetermined pitches. This structure allows the slits to function effectively as the markings since they let projected light pass therethrough whereas the other areas do not. In addition, this structure helps simplify a configuration of detecting means, since all what is required is to detect presence or absence of the light.

Also provided as the detecting means are two sensors 22 at positions equally dividing a circumferential area around the rotary shaft in a manner to face pulse plate 21. In other words, it may be appropriate to state that these sensors 22 are located at positions equally dividing the periphery of the rotary shaft. Although no specific structure of these sensors 22 is discussed here, it can be of any means capable of detecting the markings accurately from pulse plate 21, such as a pair of optical detectors, each comprising a light emitter and an optical receiver in this exemplary embodiment. The light emitter and the optical receiver are disposed in positions sandwiching the slits formed in pulse plate 21. The optical detector of this structure outputs a detection pulse representing detection of the marking when it detects the light since the light emitted from the light emitter is cut off intermittently by a series of the slits as pulse plate 21 rotates with the rotary shaft.

As discussed, the present invention is designed to generate detection pulses by a sensor pair comprised of two sensors 22 disposed next to circular pulse plate 21 which rotates with the photoconductor drum (i.e., rotationally driven member). Although this exemplary embodiment illustrates two sensors 22 disposed at the positions confronting each other across the rotary shaft of the photoconductor drum to be detected (i.e., photoconductor drum 34C for cyan image), it is not intended to limit the invented structure to the above. The structure may still be altered to increase the number of sensors 22 to three or more, which can be disposed at positions equally dividing the circumferential area around the rotary shaft.

The detection pulses generated by the sensor pair are signals (or, speed signals) that correspond to a rotating speed of the photoconductor drum. Since the sensor pair consists of two sensors 22, there are also two sets of the speed signals generated by them. This invention includes rotating speed controller (or, rotating speed control means) 23 having a function of computing an average value of these two speed signals and regulating the rotating speed of motor 31 in a manner to bring the average value into conformity with a value corresponding to a predetermined rotating speed. This function can eliminate variations in rotating speed of the photoconductor drums over their full rotating cycles, and thereby it can effectively reduce or even obviate misregistration of the images formed by the photoconductor drums throughout their rotating cycles. Accordingly, pulse plate 21 and the sensor pair (i.e., two sensors 22) in the above structure constitute rotating speed detector (or, rotating speed detection means) 30 that outputs a data of the rotating speed to rotating speed regulator 23.

Rotating speed regulator 23 can be of any configuration without limitation as long as it has the control function of effectively eliminating the rotational variations of the photoconductor drums over their full rotating cycle. A configuration utilizing feedback type control, for example, is well suited in this exemplary embodiment.

More specifically, rotating speed regulator 23 of this exemplary embodiment comprises reference pulse output section 24, averaging section 25, speed controller 26, and the like, as shown schematically in FIG. 13. Reference pulse output section 24 includes at least crystal oscillator 24a and frequency divider 24b, wherein frequency divider 24b divides an input signal of a specific frequency generated by crystal oscillator 24a into a predetermined frequency corresponding to a desired rotating speed. Reference pulse output section 24 can thus outputs a cyclic reference pulse string. Crystal oscillator 24a and frequency divider 24b may have any configurations without limitation, and those of known structures can be adopted properly. The specific structure of reference pulse output section 24 is not particularly limited to the one provided with crystal oscillator 24a and frequency divider 24b, as illustrated above, but it can be comprised of other components. However, this configuration consisting of crystal oscillator 24a and frequency divider 24b is preferable since it can be made at low cost, yet capable of generating steady reference pulses highly reliably.

Averaging section 25 shown above averages the two speed signals detected by the sensor pair, and outputs it as an average speed signal. Although no specific detail is illustrated here, a structure adapted for any known filtering process can be given as an example. The present inventors have disclosed certain concrete examples of such structure in Japanese Patent No. 3,677,145 (Japanese Patent Unexamined Publication, No. 1998-215593). Therefore, the present application makes reference to the above patent document.

Speed controller 26 controls the rotating speed of motor 31 by outputting a rotation control signal to driver 27, which in turn drives rotation of motor 31. More specifically, speed controller 26 compares the average speed signal output by averaging section 25 with the reference pulse output by reference pulse output section 24, and outputs a rotation control signal to driver 27 after increasing or decreasing a number of rotation control pulses carried by the signal in a manner to regulate the rotating speed of motor 31 to the desired speed corresponding to the reference pulse. The specific structure of speed controller 26 given here is not meant to be restrictive, but any structure known in the field of driving motors can be adopted suitably.

Rotating speed regulator 23 outputs the rotation control signal to driver 27 as described above. Driver 27 drives motor 31 according to the rotation control signal to maintain the desired rotating speed. Driver 27 and motor 31 can be of any structures without specific limitation. For example, motor 31 may be any of d.c. blushless motor, an a.c. motor, an induction motor, a stepping motor, or other motors of the known kind, and the driver can be an appropriate driving circuit suitable for such known motors.

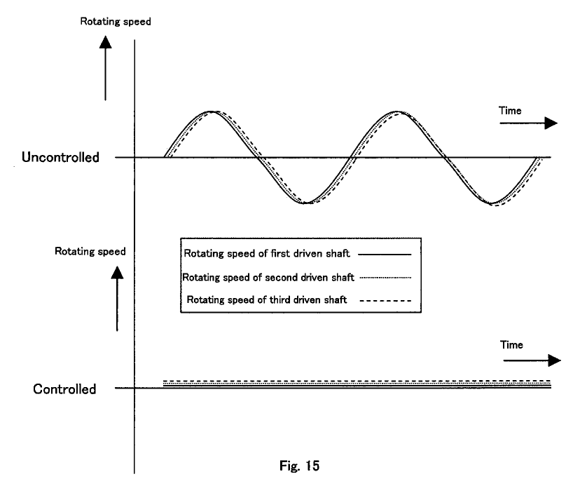

The drive unit of this structure makes it possible to practically cancel out variations in the rotating speeds among all the three photoconductor drums over their full rotating cycles by way of detecting the rotating speed of only one of the photoconductor drums, as shown in the lower part of graph in FIG. 15, wherein the three photoconductor drums for chromatic images are rotated in an interlocked motion in this plural-shaft driving system.

The patent document 3 discloses, for example, a rotation driving mechanism of the plural-shaft driving system wherein a gear train is formed by aligning rotating phases of three photoconductor drums for chromatic images over their full rotating cycles in order to abate misregistration that occurs among the three drums. It is thus possible according to this structure to align the phases of variations in the rotating speeds among the rotary shafts, as shown in the upper part of the graph indicated as “uncontrolled” in FIG. 15, so as to reduce distortion of an image. In the graphs of FIG. 15, the axis of ordinates represents variations in rotating speed, and the axis of abscissas represents rotation time. The solid line, the fine dotted line and the broken line in the graph indicate rotating speeds of the first rotary shaft, the second rotary shaft and the third rotary shaft respectively. The graph shows that the rotating speeds vary in a sinusoidal shape as time passes.

According to the above structure of the patent document 3, however, there remain some adverse factors that cause variations in the rotating speed such as pitch errors of the gears accumulated during the manufacturing process, decentering in the axis of rotation (i.e., eccentricity of rotary axis) developed in the rotation drive system, and the like. Therefore, it is difficult in this structure to reduce the variations in the rotating speed to a satisfactory level over the full rotating cycle although the rotational phases can be aligned among the photoconductor drums. It is thus difficult to effectively prevent distortion of the image attributed to the variations of the rotating speed.

According to the present invention, this rotation driving mechanism of the plural-shaft driving system has the same structure as that disclosed in the patent document 3 in respect of that the gear train is formed in a manner to align the rotating phases over the full rotating cycle. However, the present invention differs from the patent document 3 that the rotating speed detector 30 is disposed to a rotary shaft of only one of the three photoconductor drums, and the rotating speed of motor (or rotational driving source) 31 is controlled according to the output signal taken from the plurality of sensors 22 placed in the positions equally dividing the area around the rotary shaft, as shown in FIG. 13. Since this structure provides an advantage of canceling out the variations in the rotating speed of all the photoconductor drums over their full rotating cycles, it becomes possible to reduce the variations in the rotating speeds of all of first driven shaft 33a, second driven shaft 33b and third driven shaft 33c to a practically negligible level over their full rotating cycles, as shown in the bottom part of the graph in FIG. 15. This can thus make it possible to reduce distortion of the image attributable to the variations in the rotating speeds of the photoconductor drums over their full rotating cycles to an unnoticeable level. Accordingly, the embodied structure can further improve quality of the color image formed by registering the toner images of different colors.

The embodiment illustrated above is not intended to restrict the invented structure, but this invention can be applied suitably to any type of image forming apparatus provided with a plurality of photoconductor drums. A typical example of such image forming apparatus provided with a plurality of photoconductor drums is a color image forming apparatus used to form toner images of different colors. Such color image forming apparatuses generally use three colored toners of yellow (Y), magenta (M) and cyan (C). Description is therefore provided here, as the preferred embodiment of the invention, of the color image forming apparatus equipped with three photoconductor drums for chromatic images (i.e., photoconductor drums for yellow image, magenta image and cyan image).

Although the rotating speed regulator illustrated in this exemplary embodiment has the structure using the feedback control, this is not restrictive, and the regulator can be configured with the known technique of learning control. In other words, the regulator of this invention only needs to have the function of controlling the rotating speed in a manner to eliminate the variations of the rotating speed over the full rotating cycle by steadily generating a signal of average value obtained from the outputs of the plurality of sensors.

Examples of the sensor pair for detecting the rotating speed of the photoconductor drum suitable for use in this invention include, but not limited to, two sensors as disclosed in Japanese Patent Unexamined Publication, No. 1999-341854 filed by the applicant of this patent application (the sensors are shown in FIG. 12 and FIG. 21 under the designations of sensors 8b1 and 8b2, the disclosure of which is quoted elsewhere in this specification as reference patent document 1), and a second sensor as disclosed in Japanese Patent Unexamined Publication, No. 2003-018880 (the sensor comprises pulse plate 5a and two sensors 5b and 5c shown in FIG. 14, the disclosure of which is also quoted in this specification as reference patent document 2).

The rotation drive units disclosed in both reference patent documents 1 and 2 are suitable for use as the driving means of photoconductor drums in the color image forming apparatus. However, since the drive unit of the reference patent document 1 employs a traction type reduction mechanism as the reduction means, it is not designed in a practical sense to drive three photoconductor drums for chromatic images of Y, M and C with a single motor. Therefore, the technique disclosed in the reference patent document 1 is useful only in a “four-motor system” wherein the photoconductor drums are driven individually by their respective motors to effectively abate variations in rotating speeds of the photoconductor drums (designated as rotating members in the reference patent document 1) and achieve accurate control of the rotating speeds, but it does not disclose novel information any further than the above.

The reference patent document 2 discloses a technique of using a geared reduction mechanism as reduction means, and a sensor pair for canceling components of speed variations over a full rotating cycle of driven shafts of the reduction mechanism. Furthermore, the geared reduction mechanism shown in this reference patent document 2 has a first intermediate gear and a second intermediate gear arranged in a manner that their phases (i.e., angular orientations of the gear teeth) are shifted by 180 degrees with respect to each other to cancel out the variations in the rotating speeds between the gears. In other words, although the technique disclosed in this reference patent document 2 is very effective for reducing the variations in the rotating speeds of the geared reduction mechanism, it does not disclose novel information any further than the above.

On the other hand, the present invention is contrived for the purpose of making a transmission system of the structure capable of driving three photoconductor drums for chromatic images of Y, M and C with a single motor, and a photoconductor drum for black image with another motor independently from the three photoconductor drums, to register the toner images formed by the individual photoconductor drums satisfactorily.

On the contrary, the drive unit disclosed in the reference patent document 1 drives the rotating members individually by the same number of the driving sources by using frictional transmission means represented by the tractional reduction unit, and another structure disclosed in the reference patent document 2 is designed to align the phases of the intermediate gears in the manner to reduce the variations in the rotating speeds between the gears inside the geared reduction mechanism. The above structure of the reference patent document 1 is not applicable to the structure of this invention, which drives the three photoconductor drums for Y, M and C images with a single motor. On the other hand, the structure of the reference patent document 2 is completely different from the structure of this invention, which is designed to align the phases of the gears that constitute the gear train for driving three photoconductor drums for Y, M and C images.

As described above, the present invention is achieved as a result of the earnest efforts to overcome the aforesaid drawbacks and their factors based upon the inventions accomplished earlier by the applicants and disclosed in the reference patent documents 1 and 2, and therefore this invention is far superior to the above inventions.

As discussed, the present invention pertains to the rotation drive system (referred to as a “plural-shaft driving system” for convenience's sake) comprising a plurality of gears having the same structure with rotary shafts attached to the centers of the individual gears in a manner to rotate in the same direction at the same speed by a single driving source, the plurality of gears assembled with their rotational phases aligned over the full rotating cycle to constitute a gear train, a pulse plate mounted to one of the rotary shafts connecting a plurality of photoconductor drums, a plurality of sensors provided at positions equally dividing a circumferential area around the rotary shaft, wherein a rotating speed of the driving source is controlled in a manner to bring an average value of a plurality of speed signals output by the sensors into conformity with a value corresponding to a predetermined rotating speed.

According to the above structure, it becomes possible to practically eliminate variations of the rotating speed of one of the photoconductor drum by leveling off the variations of the rotating speed substantially over the full rotating cycle thereof. This effect of eliminating the variations of one photoconductor drum also extends to the other photoconductor drums rotated in an interlocked motion. This structure can thus provide an advantage of effectively avoiding or reducing distortion of the image formed by the photoconductor drums over their full rotating cycles.

### Sixth Exemplary Embodiment

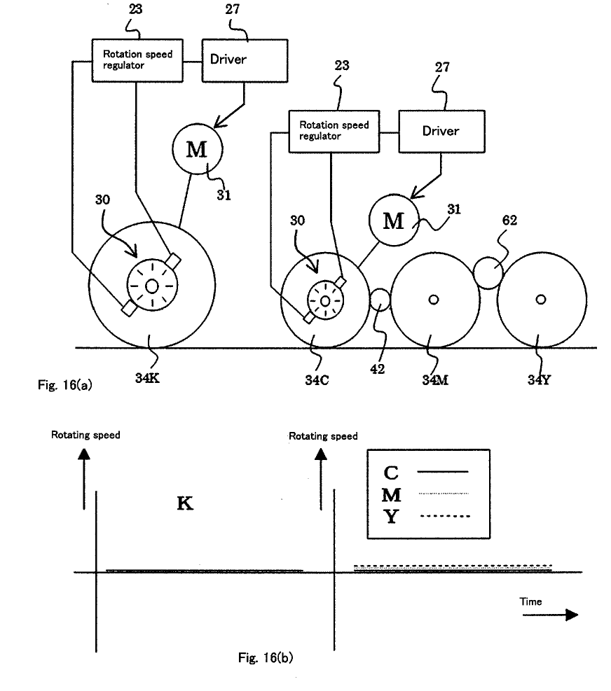

Description is provided hereinafter of still another exemplary embodiment with reference to FIG. 16 to FIG. 20. It should be understood that the exemplary embodiment described below is not to be taken as restrictive, but the invention may be embodied or practiced in still many other ways, and all changes which come within the meaning of the claims are intended to be embraced therein. Like reference numerals are used throughout to designate components having substantially similar structures or practically same functions and characteristics as those of the fifth exemplary embodiment, and details of them will be omitted.

The drive unit and the method of driving the same discussed in the fifth exemplary embodiment cover only about the structure of ganged mechanism for driving the photoconductor drums that form toner images of chromatic color (i.e., structure of the plural-shaft driving system) used in an image forming apparatus. This exemplary embodiment further encompasses a structure having an independent photoconductor drum in addition to the ganged photoconductor drums of the above plural-shaft driving system, the independent photoconductor drum being driven by a driving source different from that of the ganged photoconductor drums, and provided with the same rotating speed detector and the rotating speed regulator.

The structure of this exemplary embodiment comprises a rotating speed controller consisting of the first reduction mechanism and the second reduction mechanism discussed in the first to fourth exemplary embodiments and additional rotating speed controller consisting of the rotating speed detector and the rotating speed regulator discussed in the fifth exemplary embodiment.

In other words, a color image forming apparatus shown in this exemplary embodiment is provided with three photoconductor drums for chromatic color images, including photoconductor drum 34Y for yellow image, photoconductor drum 34M for magenta image and photoconductor drum 34C for cyan image, in the like manner as the fifth exemplary embodiment. In addition, the apparatus also comprises an independent photoconductor drum 34K for black toner image, as shown in FIG. 16(a).

Photoconductor drum 34K for black image is driven by a rotation drive system (i.e., driver 27, motor 31 and a speed reduction mechanism though not shown in FIG. 16(a)), which is independent from the drive system for the three photoconductor drums for chromatic images, and it is provided with rotating speed detector 30 (i.e., the aforesaid structure including pulse plate 21 and a sensor pair) and rotating speed regulator 23, as similar to the three photoconductor drums for chromatic images. Since concrete structures of the rotation drive system, rotating speed detector 30 and rotating speed regulator 23 have been illustrated in the fifth exemplary embodiment, they are not repeated here.

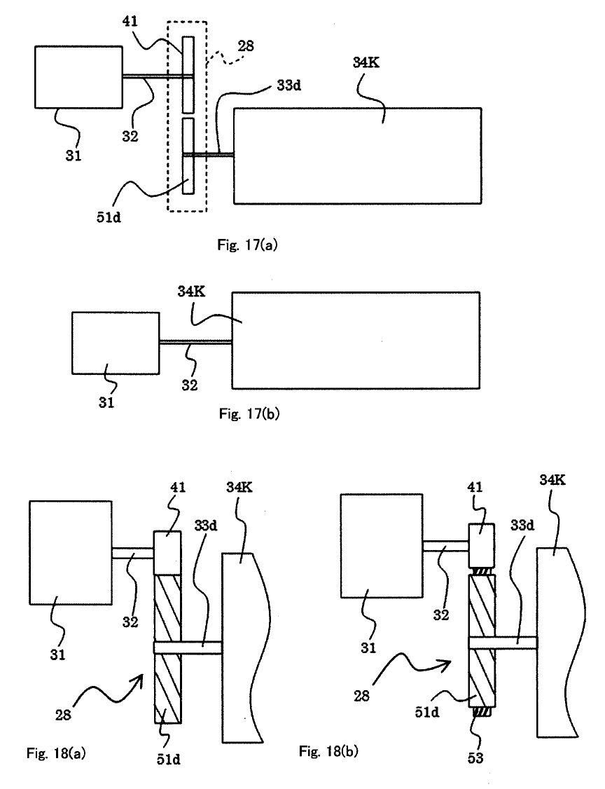

The above rotation drive system of photoconductor drum 34K for black image may be provided with an additional reduction mechanism of some kind for reducing a speed of the rotational driving force from motor 31. Specific examples of such reduction mechanism include speed reduction unit 28 of traction transmission system such as the one shown in FIG. 17(a) and a speed reduction unit using a series of gears (gear transmission system) such as the gear train discussed earlier. It is especially desirable to use speed reduction unit 28 of the traction transmission system shown in FIG. 17(a) for transmitting the rotational driving force by the frictional force between drive roller 41 attached to drive shaft 32 of motor 31 and driven roller 51d attached to driven shaft 33d of photoconductor drum 34K for black image. This structure is to avoid using gears for driving rotation of photoconductor drum 34K during formation of monochromic images, of which a frequency of use is very high. The advantage of this is to achieve the silencing of the image forming apparatus by reducing operating noises, and to improve the quality of frequently used monochromic images.

Alternatively, the rotation drive system of the photoconductor drum for black image may be composed without using a reduction mechanism. That is, photoconductor drum 34K may be driven directly by motor 31 (i.e., direct drive motor) as shown in FIG. 17(b). As is known, the structure driven directly by the independent driving source can eliminate the gears for rotating the photoconductor drum when forming frequently used monochromic images. It can hence achieve the silencing of the image forming apparatus by reducing the operating noises.

In the above rotation drive system of the photoconductor drum for black image, speed reduction unit 28 of the traction system may be of any structure without specific limitation, such as the one shown in FIG. 17(a), which comprises drive roller 41 attached to drive shaft 32 of motor 31 and driven roller 51d attached to driven shaft 33d of photoconductor drum 34K for black image with their roller surfaces kept in frictional contact in a manner to transmit the rotational driving force while reducing the rotating speed. A configuration having two rollers made of a metal or a polymeric resin and so disposed as to contact with each other is a specific example of this system.

It is more desirable in this exemplary embodiment that driven roller 51d is provided with elastic annular member 53 on its surface as shown in FIG. 18(b). The elastic material on the surface of driven roller 51d can transmit the rotational driving force from drive roller 41 to driven roller 51d since it helps maintain the proper contact between the roller surfaces while absorbing a thrust on the surfaces adequately.

Materials suitable for the above elastic material are not limited to any specific kind, as long as it has a self-retentive property with sufficient durability for transmission of the rotational driving force and an easily deformable elasticity to an externally applied force. Typical materials having the above physical properties include rubbers of various kinds.

Examples of such rubber materials include, but not limited to: natural rubber; synthetic diene rubber such as isoprene rubber, butadiene rubber, styrene-butadiene rubber, chloroprene rubber, acrylonitrile-butadiene rubber (nitrile rubber), etc.; synthetic non-diene rubber such as butyl rubber, ethylene propylene rubber, urethane rubber, silicone rubber, chlorosulfonate rubber, chlorinated polyethylene, acrylic rubber, epichlorohydrin rubber, fluorine rubber, etc. Although it is the normal practice to use only one kind selected from the rubber materials listed above, these rubber materials may be used in a form of a rubber alloy or a multi-layered structure by combining or laminating a plurality of the materials of different kinds. Specific examples of the multi-layered structure are not discussed here, except that one such example may be a double-layered structure comprising an inner layer made of a rubber material having effective impact resilience and an outer layer made of another rubber material of high coefficient of friction. In addition, the above rubber materials may be used in combination with any known additives. It is especially preferable for this application to use a rubber material of superior ozone resistance such as hydrogen-added nitrile rubber (e.g., hydrogenated nitrile rubber, or H-NBR).

In the aforesaid example structure, although driven roller 51d is provided on its surface with the elastic material of annular shape, it is not intended to define or limit the present invention only to this structure. Instead, such an elastic annular member may be attached to the surface of drive roller 41, although not shown in the figure. Alternatively, the structure may be altered such that both driven roller 51d and drive roller 41 are provided on their respective surfaces with elastic annular members having different physical properties such as surface friction, elasticity, etc. that affect the condition of thrust contact though not shown in the figure. Or the structure may even be so altered that at least one of driven roller 51d and drive roller 41 is made entirely of a solid elastic material.

In this exemplary embodiment here, photoconductor drum 34K for black image is driven independently of the other photoconductor drums for chromatic images, and variations in the rotating speed over the full rotating cycle of photoconductor drum 34K is reduced also independently of the photoconductor drums for chromatic images by means of rotating speed detector 30 and rotating speed regulator 23. Since the above structure reduces the variations in the rotating speeds of all of the three photoconductor drums for chromatic images over their full rotating cycles, it can eliminate the variations in the rotating speeds of these photoconductor drums for cyan image, magenta image and yellow image to practically negligible levels over their full rotating cycle as shown in the right side of the graph in FIG. 16(b), wherein the rotating speeds of the above three photoconductor drums are identified by the characters of “C”, “M” and “Y”, in addition to the advantage of eliminating the variations in the rotating speed of the photoconductor drum for black color image to the practically negligible level over its full rotating cycles as shown by the character of “K” in the left side of the graph in FIG. 16(b).

As a result, the above structure makes it possible not only to reduce distortion of the image attributable to the variations in the rotating speeds of the photoconductor drums over their full rotating cycles, but also give designing flexibility such as increasing a capacity of the independent driving source for driving photoconductor drum 34K for black image to a value greater than that of the ganged photoconductor drums for chromatic images, or increasing a diameter of the photoconductor drum for black image larger than that of the other photoconductor drums. The above structure can further improve quality of the color image formed by registering the toner images of different colors, beside the advantages noted below.

(1) It does not require an initial process of aligning the phases between photoconductor drum 34K for black image and the other photoconductor drums for chromatic images prior to the start of rotating these photoconductor drums since it virtually eliminates distortion of an image over the full rotating cycle of the photoconductor drums, and it can therefore shorten a time necessary to produce the image.

(2) It does not require designing of photoconductor drum 34K for black image to harmonize various rotating conditions with those of the other photoconductor drums for chromatic images since there is no need to align the phases between them. This gives the flexibility of increasing the capacity of the rotation drive system of photoconductor drum 34K for black image to thereby extend an operating life of the frequently used photoconductor drum 34K longer than that of the other photoconductor drums for chromatic images, of which a frequency of use is relatively low.

(3) It gives the flexibility of increasing the diameter of photoconductor drum 34K for black image beyond that of the other photoconductor drums for chromatic images since there is no need to align the phases between them. Because of the frequent usage, it is often desirable to increase not only the capacity of the rotation drive system of photoconductor drum 34K for black image but also the diameter of photoconductor drum 34K to increase the printing speed (i.e., an image forming speed) of the monochrome images only.

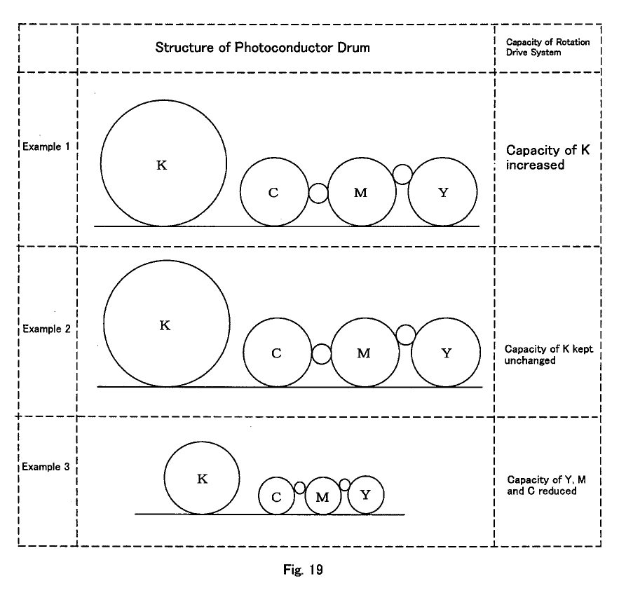

Description is provided in more details of techniques of increasing the capacity and the diameter of photoconductor drum 34K for black image. Here, an increase in the capacity of the rotation drive system can be attained by increasing a torque (i.e., a driving torque) or a number of rotations (i.e., a number of revolutions per unit time), or both, because the capacity (W) of the rotation drive system is given as the product of the torque and the number of rotations (i.e., torque×number of rotations). Consideration is given on two exemplary cases associated with a structure having photoconductor drum 34K for black image of a larger diameter than that of the other photoconductor drums for chromatic images, as shown in FIG. 16(a), of which one case is to keep a reduction ratio for driving photoconductor drum of 34K unchanged at generally the common setting (i.e., capacity of K increased to maintain the same reduction ratio) as indicated in the example 1 of FIG. 19, and the other case is to increase the reduction ratio for photoconductor drum of 34K (i.e., capacity of K kept unchanged by increasing the reduction ratio) as indicated in the example 2 of FIG. 19.

In any of the examples 1 and 2, the increase in the diameter of photoconductor drum 34K can expand a surface area thereof, whereon an electrostatic latent image is formed. This allows a reduction in the frequency of rotation of photoconductor drum 34K for black image, and it can therefore extend the designed life expectancy of photoconductor drum 34K.

Additionally, in the case of example 1, the speed of forming the normal monochromatic images can be increased in proportion to the increase in the diameter of photoconductor drum 34K since the reduction ratio for driving photoconductor drum 34K is kept unchanged. On other hand, the rotating speed of the photoconductor drum 34K is reduced to bring it in harmony with the photoconductor drums for chromatic images when forming chromatic images, whereas the high image forming speed is maintained when forming monochromatic images. The structure of this example can hence achieve a high-speed formation of monochromatic images, the need of which is more frequent.

In the case of example 2, the reduction ratio for driving photoconductor drum 34K is increased to bring the image-forming speed in harmony with those of the photoconductor drums for chromatic images. This helps extend the designed life expectancy of the rotation drive system of photoconductor drum 34K for black image. Generally, the operating life of the rotation drive system of photoconductor drum 34K for black image tends to become shorter because of the more frequent usage as compared to the rotation drive system of the photoconductor drums for chromatic images, of which the frequency of use is lower and thereby leave a good margin of expected life in the design. Because of this reason, the design life of the rotation drive system of photoconductor drum 34K for black image has been the determinant factor of the operating life of the entire apparatus. In contrast to this, the structure of this example can extend the operating life of the rotation drive system of photoconductor drum 34K for black image, and it can therefore extend the life span of the image forming apparatus as a whole.

It is also possible to reduce the diameter of the photoconductor drums for chromatic images without changing the diameter of photoconductor drum 34K for black image, as shown in the example 3 of FIG. 19. With the reduction of the diameter of the photoconductor drums for chromatic images, the capacity of the driving source for these drams may also be reduced. In the structure of this example, the image forming apparatus is so designed that the design life of the rotation drive system of the less-frequently used photoconductor drums for chromatic images is held down while the design life of the rotation drive system of photoconductor drum 34K for black image is kept unchanged. As mentioned above, the rotation drive system of photoconductor drum 34K for black image is often the bottleneck of the operating life of the color image forming apparatus. Reducing the design life of the photoconductor drum for chromatic images into harmony with the design life of photoconductor drum 34K for black image can make it possible not only to avoid redundancy but also to produce the photoconductor drum for chromatic images and the rotation drive system at low cost. This can provide an advantage of cutting down the cost of the image forming apparatus without sacrificing the life span thereof.

In any of the examples 1 to 3, the rotating speed of the photoconductor drum 34K for black image may properly be lowered to make it into harmony with the photoconductor drums for chromatic images when forming chromatic images. There are number of known techniques available for use as methods of controlling rotational drive in the above manner.

It is more desirable to use a structure having two reduction mechanisms provided in parallel for the rotation drive system of the photoconductor drums for chromatic images according to this invention.

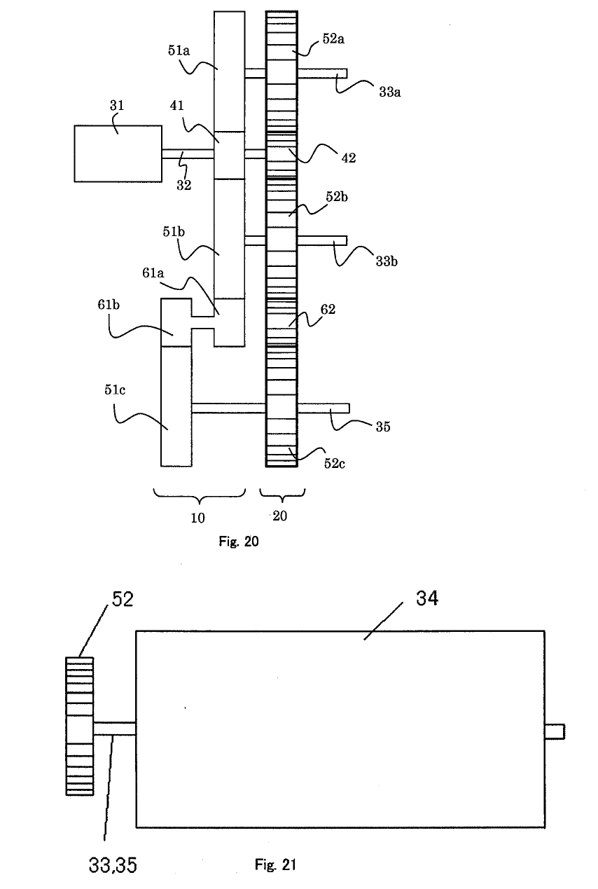

A typical example of such structure is shown in FIG. 20, which comprises roller train 71 formed of a plurality of rollers mounted to a series of shafts in combination with corresponding gear train 72 of the same configuration as the one illustrated previously in the fifth exemplary embodiment (refer to FIG. 14).

That is, drive shaft 32 is provided with drive roller 41 in addition to drive gear 42, and first driven shaft 33a, second driven shaft 33b and third driven shaft 35 are provided in the similar manner with first driven roller 51a, second driven roller 51b and third driven roller 51c in addition to first driven gear 52a, second driven gear 52b and third driven gear 52c respectively. This structure also includes idle rollers 61a and 61b between second driven roller 51b and third driven roller 51c.

The above drive roller 41 is in contact with first driven roller 51a and second driven roller 51b in a rotatable manner to transmit a rotational driving force of motor 31 from drive shaft 32 to first driven shaft 33a and second driven shaft 33b. Second driven roller 51b transmits the rotational driving force to third driven roller 51c via idle rollers 61a and 61b. Accordingly, when the above gear train is named a reduction mechanism, the roller train also constitutes another reduction mechanisms. Second driven roller 51b and third driven roller 51c are disposed in parallel to each other with their rotating planes shifted in the axial direction to avoid the peripheral roller surfaces from contacting with each other, and idle rollers 61a and 61b are disposed in the corresponding positions.

In this structure of the two reduction mechanisms, a reduction ratio of rotating speed of the reduction mechanism using traction system comprised of roller train 71 is set larger than that of another reduction mechanism comprised of the gear transmission system under no load condition (i.e., when the traction type reduction mechanism is operated independently). Since the reduction mechanism of the traction system transmits the rotational driving force by the frictional contact between the rollers, it is forced to rotate at a rotating speed equal to that of the reduction mechanism of the gear transmission system while making slippage between the rollers. Accordingly, the reduction mechanism of the traction system generates a braking effort while making slippage between the rollers during transmission of the rotational driving force from the drive shaft, and this gives a torque load on the reduction mechanism of the gear transmission system. Since this structure transmits the rotational driving force through the route of the traction system while exerting the load upon the other route of the gear transmission system in this manner, it can provide a satisfactory and reliable speed-reducing operation of the three photoconductor drums even with a single motor. In addition this structure can also transmit the rotational driving force reliably and accurately even if it is equipped with the plurality of driven shafts coupled to the single drive shaft.

Furthermore, the load delivered from the drive shaft to the driven shafts through the engaged portions of the gears is supplemented by the tractional force of the rollers, this structure ensures the reliable engagement of the gears as compared to the ordinary structure relying solely upon the gear transmission system (i.e., the structure shown in FIG. 14). This structure can therefore abate the meshing noises of the gears as well as operating noises of the image forming apparatus, and further improve quality of the formed images. This structure, in combination with the novel features of the aforesaid rotating speed detector and the rotating speed regulator, can provide an outstanding effect of improving various performances of the image forming apparatus.

This dual speed reduction mechanism consisting of the traction transmission system and the gear transmission system can be used suitably not only for the photoconductor drums for chromatic images operated in tandem with the plurality of driven shafts but also for the photoconductor drum for monochromatic image. This helps achieve a further reduction of the operating noises in the group of the photoconductor drums, and alleviate variations in rotation of the driven shafts attributed to intermeshing of the gears. It hence improves further the performances of the color image forming apparatus. In this invention, driven shafts 33 and 35 (i.e., first driven shaft 33a, second driven shaft 33b and third driven shaft 35) are extended, and photoconductor drums 34 (i.e., photoconductor drum 34C for cyan image, photoconductor drum 34M for magenta image and photoconductor drum 34Y for yellow image) are mounted to the lengths of the shafts. This structure securely integrates the individual photoconductor drums 34 with their corresponding driven shafts 33 and 35, to improve the rotating speed of photoconductor drums 34, and thereby yield images of less distortion (refer to FIG. 21). FIG. 21 is a schematic view illustrating the photoconductor drums attached to the extended driven shafts of the drive unit shown in FIG. 20.

According to the present invention, as described, the drive unit of the plural-shaft driving system is used for driving the photoconductor drums for producing chromatic images, beside the independently driven photoconductor drum for producing a black image, so that the rotating speed of the rotational driving source of the photoconductor drum for black image can be controlled in the same manner as discussed above.

Accordingly, this simple structure having two rotational driving sources such as motors can practically eliminate the variations in the rotating speeds of all of the photoconductor drums for chromatic images and the photoconductor drum for black image over their full rotating cycles. The above structure not only can effectively reduce or even obviate distortion of the images formed by the photoconductor drums through their rotating cycles, but also allow flexibility of selecting the diameter of the independent photoconductor drum for black image and a rotatory capacity of the driving unit, which is defined as the product of torque load and rotating speed. It can thus provide such advantageous features as substantial improvement of the performances of the color image forming apparatus, reducing the cost and extending the useful life span.

As described, the rotation drive unit according to the present invention is installed in an image forming apparatus provided with a plurality of photoconductor drums for forming toner images of different colors, the plurality of photoconductor drums comprising ganged photoconductor drums having same diameter and rotated in a linked motion by a rotational driving force of a single driving source, wherein the ganged photoconductor drums are provided with driven gears formed by a same single molding die and attached individually to rotary shafts thereof, the driven gears are aligned in the same orientation to balance dimensional deviations in their pitch radii at their engaged portions and assembled with an intermediate gear disposed between every adjoining driven gears to compose a gear train in a manner so that all the driven gears are rotated in the same direction at the same rotating speed in a synchronized orientation in their rotating phase, and the rotation drive unit further comprises a pulse plate having markings formed in a circular pattern at equal intervals and mounted to one of the rotary shafts of the ganged photoconductor drums, detecting means disposed at positions equally dividing a circumferential area around the rotary shaft for detecting the markings on the pulse plate and generating a speed signal, and a rotating speed regulating means for regulating a rotating speed of the driving source based on the speed signal generated by the detecting means in a manner to bring a speed of the rotary shaft into conformity with a predetermined rotating speed.

It is desirable in the above drive unit that all of the ganged photoconductor drums are photoconductor drums for producing toner images of chromatic colors, and it is more desirable that they comprise photoconductor drums for yellow image, magenta image and cyan image.

It is also desirable in the above drive unit that the detecting means comprise at least two units disposed at positions equally dividing the circumferential area around the rotary shaft of one of the ganged photoconductor drums being monitored, so that the rotating speed of the driving source is regulated in a manner to bring an average value of speed signals generated by these at least two units of the detecting means into conformity with a given value corresponding to the predetermined rotating speed.

In addition, the above drive unit is provided with an independent photoconductor drum driven by a different driving source from that of the ganged photoconductor drums. It is desirable that the independent photoconductor drum is also provided with the same pulse plate, detecting means and rotating speed regulating means, and it is more desirable that the independent photoconductor drum is a photoconductor drum for producing a black toner image. It is also desirable that a capacity of the separate rotation drive system for driving the independent photoconductor drum is formed greater than that of the rotation drive system for the ganged photoconductor drums. Or, it is more desirable that a diameter of the independent photoconductor drum is formed larger than that of the ganged photoconductor drums.

Moreover, it is desirable that the above drive unit is provided with a speed reduction means for reducing a speed of the rotational driving force of the driving source for driving the independent photoconductor drum, and it is more desirable that the speed reduction means is a reduction unit of the tractional system for transmitting the rotational driving force by means of friction between the rollers.

In the above drive unit, it is desirable that the independent photoconductor drum is rotatably driven directly by the separate driving source used independently for the drum.

Furthermore, it is desirable in the above drive unit that at least one of the rotation drive system for driving the independent photoconductor drum and the other rotation drive system for driving the ganged photoconductor drums is provided with a speed reduction unit of the tractional system for transmitting the rotational driving force by frictional force between rollers as well as a speed reduction unit of the gear system for transmitting the rotational driving force by meshed gears.

The image forming apparatus according to the present invention includes the above drive unit.

Therefore, the image forming apparatus of the present invention uses both of first reduction mechanism of the tractional transmission system and second reduction mechanism of the gear transmission system to transmit a rotational driving force of a single driving source to driven shafts, thereby providing outstanding advantages and effects of decreasing noises of the driving operation, reducing variations of the rotating speed, and the like. Since this invention can provide the novel advantage of practically eliminating the variations of the rotating speed of the photoconductor drums over their full rotating cycles, it gives remarkable advantages and effects of improving the design flexibility such as increasing the rotating speed or the diameter of the more frequently used photoconductor drum for black image, and eliminating the need to carry out the complex process of aligning the phases among the photoconductor drums.

Accordingly, the present invention is applicable widely to apparatuses and components of various kinds that require rotational driving mechanisms with or without speed reduction, and manufacturing thereof in many fields. The present invention is especially useful in the field of color image forming apparatuses equipped with a plurality of photoconductor drums.

What is claimed is:

1. A rotation drive unit comprising:
a rotation drive mechanism provided with a drive shaft and a driven shaft juxtaposed in parallel to each other;
at least a drive gear attached to the drive shaft in concentricity with the rotational axis thereof; and
at least a driven gear attached to the driven shaft in concentricity with the rotational axis thereof, wherein
the drive gear and the driven gear are rotatably engaged to compose a gear train for transmitting a rotational driving force of the drive shaft to the driven shaft, and
the rotation drive unit further comprises a rotating speed control means for reducing a deviation of an actual value from an expected value in rotating speed of a rotationally driven member in concentricity with the rotating axis of the driven shaft when the driven shaft is engaged to the rotationally driven member, wherein the expected value denotes a rotating speed of the rotationally driven member expected according to a rotating condition of the drive shaft, and the actual value denotes an actual rotating speed of the rotationally driven member.

2. The rotation drive unit according to claim 1 further comprising:
a drive roller attached to the drive shaft in concentricity with the rotational axis of the drive shaft and the drive gear; and
a driven roller attached to the driven shaft in concentricity with the rotational axis of the driven shaft and the driven gear, wherein
the drive roller and the driven roller are rotatably in contact with each other to constitute a first reduction mechanism for transmitting the rotational driving force of the drive shaft to the driven shaft,
the gear train constitute a second reduction mechanism for transmitting the rotational driving force of the drive shaft to the driven shaft, and
a reduction ratio of rotating speed of the first reduction mechanism is set to be different from a reduction ratio of rotating speed of the second reduction mechanism when the first reduction mechanism and the second reduction mechanism are compared on an assumption of transmitting the rotational driving force independently from the drive shaft to the driven shaft.

3. The rotation drive unit according to claim 2, wherein the reduction ratio of rotating speed of the first reduction mechanism is set to be larger than the reduction ratio of rotating speed of the second reduction mechanism.

4. The rotation drive unit according to claim 2, wherein the drive shaft has a plurality of driven shafts provided in association therewith, and the first reduction mechanism and the second reduction mechanism are provided between the individual driven shafts and the drive shaft.

5. The rotation drive unit according to claim 4, wherein the individual driven gears attached to the plurality of driven shafts in the second reduction mechanism are engaged with a difference in phase of half a working pitch of gear teeth at an engaged position between the adjoining driven gears.

6. The rotation drive unit according to claim 2 further comprising an indirectly driven shaft for receiving the rotational driving force of the drive shaft indirectly from the driven gear attached to a directly driven shaft, where the directly driven shaft defines any of the driven shafts constituting the first reduction mechanism and the second reduction mechanism in combination with the drive shaft.

7. The rotation drive unit according to claim 6 further comprising a driven gear attached to the indirectly driven shaft, and an idle gear disposed in a manner to engage with both the driven gear on the indirectly driven shaft and the driven gear on the directly driven shaft.

8. The rotation drive unit according to claim 7 further comprising a driven roller attached to the indirectly driven shaft, and an idle roller next to the idle gear, wherein both the driven roller on the directly driven shaft and the driven roller on the indirectly driven shaft are rotatably in contact with the idle roller for receiving the rotational driving force transmitted from the drive shaft.

9. The rotation drive unit according to claim 8, wherein a reduction ratio of rotating speed of a first reduction mechanism is set to be larger than a reduction ratio of a second reduction mechanism when compared on the assumption that the first reduction mechanism and the second reduction mechanism are operated independently for transmitting the rotational driving force of the drive shaft to the driven shaft, where the first reduction mechanism defines a roller train comprising the driven roller on the directly driven shaft, the idle roller and the driven roller on the indirectly driven shaft, and the second reduction mechanism defines a gear train comprising the driven gear on the directly driven shaft, the idle gear and the driven gear on the indirectly driven shaft.

10. The rotation drive unit according to claim 2, wherein the driven roller and the driven gear are unitary formed into a unit component.

11. The rotation drive unit according to claim 4, wherein all of the driven gears attached to the plurality of driven shafts are formed with a same single molding die.

12. The rotation drive unit according to claim 11, wherein all of the driven gears formed with the same single molding die are aligned in the same orientation in their pitch radii at engaged portions thereof and assembled to compose a gear train.

13. The rotation drive unit according to claim 2, wherein the driven roller is provided with an elastic annular member made of at least an elastic material, the annular member attached to a surface of the driven roller in contact with another roller.

14. The rotation drive unit according to claim 13, wherein the elastic material comprises a rubber.

15. The rotation drive unit according to claim 14, wherein the rubber include at least a hydrogen-added nitrile rubber (hydrogenation nitrile rubber, or H-NBR).

16. The rotation drive unit of claim 1 installed in an image forming apparatus provided with a plurality of photoconductor drums for forming toner images of different colors, the photoconductor drum representing the rotationally driven member, wherein
the plurality of photoconductor drums include a plurality of ganged photoconductor drums having same diameter and rotated in a linked motion by a rotational driving force of a single driving source,
the ganged photoconductor drums are provided with driven gears formed with a same single molding die, and attached individually to rotary shafts thereof,
the driven gears are aligned in the same orientation in their pitch radii at their engaged portions and assembled with an intermediate gear disposed and meshed between every adjoining driven gears to compose a gear train, and
the rotation drive unit further comprises a pulse plate having markings formed in a circular pattern at equal intervals and mounted to one of the rotary shafts of the ganged photoconductor drums,
detecting means disposed at positions equally dividing a circumferential area around the rotary shaft for detecting the markings on the pulse plate and generating a speed signal,
a rotating speed regulating means for regulating a rotating speed of the driving source based on the speed signal generated by the detecting means in a manner to bring a speed of the rotary shaft into conformity with a predetermined rotating speed, and
the pulse plate, the detecting means and the rotating speed regulating means constitute a rotating speed control means.

17. The rotation drive unit according to claim 16, wherein the ganged photoconductor drums comprise a photoconductor drum for yellow image, a photoconductor drum for magenta image and a photoconductor drum for cyan image.

18. The rotation drive unit according to claim 16, wherein at least two units of the detecting means are disposed at positions equally dividing a circumferential area around the rotary shaft of the photoconductor drum being monitored, and the rotating speed regulating means regulates the rotating speed of the driving source in a manner to bring an average value of speed signals generated by the two detecting means into conformity with a value corresponding to the predetermined rotating speed.

19. The rotation drive unit according to claim 16, wherein the image forming apparatus is further provided with an independent photoconductor drum driven by a driving source different from the driving source of the ganged photoconductor drums, and the independent photoconductor drum is also provided with the same pulse plate, detecting means and rotating speed regulating means.

20. The rotation drive unit according to claim 19, wherein the independent photoconductor drum comprises a photoconductor drum for producing a black toner image.

21. The rotation drive unit according to claim 19, wherein a capacity of the driving source for driving the independent photoconductor drum is greater than the driving source for the ganged photoconductor drums.

22. The rotation drive unit according to claim 19, wherein a diameter of the independent photoconductor drum is larger than a diameter of the ganged photoconductor drums.

23. The rotation drive unit according to claim 19, wherein at least one of the driving source for driving the independent photoconductor drum and the other driving source for driving the ganged photoconductor drums is provided with both of a speed reduction unit of tractional system for transmitting the rotational driving force by frictional force between rollers and a speed reduction unit of gear system for transmitting the rotational driving force by meshed gears.

24. An image forming apparatus comprising:
a rotation drive mechanism provided with a drive shaft and a driven shaft juxtaposed in parallel to each other;
at least a drive gear attached to the drive shaft in concentricity with the rotational axis thereof; and
at least a driven gear attached to the driven shaft in concentricity with the rotational axis thereof, wherein
the drive gear and the driven gear are rotatably engaged to compose a gear train for transmitting a rotational driving force of the drive shaft to the driven shaft, and
the image forming apparatus further comprises a rotating speed control means for reducing a deviation of an actual value from an expected value in rotating speed of a photoconductor drum in concentricity with the rotating axis of the driven shaft when the driven shaft is engaged to the photoconductor drum, wherein the expected value denotes a rotating speed of the photoconductor drum expected according to a rotating condition of the drive shaft, and the actual value denotes an actual rotating speed of the photoconductor drum.
